(19) United States
(12) Patent Application Publication
(10) Pub. No.: US 2011/0044335 A1
(43) Pub. Date: Feb. 24, 2011

(54) INFORMATION PROCESSOR, RECEIVER, TRANSMITTER, CONTROL DEVICE AND CONTROL PROGRAM

(75) Inventor: Kinya Ono, Saitama (JP)

Correspondence Address: YOUNG & THOMPSON, 209 Madison Street, Suite 500, Alexandria, VA, 22314, US

(73) Assignee: PIONEER CORPORATION, Kawasaki-shi, Kanagawa (JP)

(21) Appl. No.: 12/937,570

(22) PCT Filed: Apr. 17, 2008
(86) PCT No.: PCT/JP2008/057531

§ 371 Date: Nov. 4, 2010

(51) Int. Cl. H04L 12/56

(52) U.S. Cl. 370/389

(57) ABSTRACT

In an information processing apparatus, the pre-reproduction connection information retaining element retains the information relating to the transmitting apparatus and the receiving apparatus of a connection existing before a reproduction of an interruption signal, when the connection is switched to the connection for transmitting the interruption signal in order to reproduce the interruption signal. Then, the recovering element recovers the connection existed before the reproduction of the interruption signal, based on the pre-reproduction connection information retained, after the reproduction of the interruption signal ends. The information processing apparatus is a transmitting apparatus and/or a receiving apparatus forming the car AV system. By this, in case that only one logical input plug can be prepared due to the restriction of hardware resource, the information processing apparatus can recover the connection, after the interruption signal reproduction ends, with keeping the user unconscious.

### TECHNICAL FIELD

The present invention relates to a method of recovering a connection.

### BACKGROUND TECHNIQUE

IEEE1394 is known as a high speed serial digital interface which transfers real-time data, such as video and audio, isochronously and transfers control data asynchronously. FIG. 1 shows an outline of IEEE1394 associated standards. In order to perform isochronous transfer by IEEE1394, it is necessary to establish a logical connection between a transmitting apparatus and a receiving apparatus of video and audio, and it is known as CMP (Connection Management Procedure) in IEC61883-1 as shown in FIG. 2.

The connection establishment is realized by associating, by channel information, a logical output plug of the transmitting apparatus with a logical input plug of the receiving apparatus, by using the transaction of IEEE1394. For the transmission protocol of IEEE1394, at present, MPEG-2-TS, BT.601, DV are defined as video and A&M is defined as audio.

The control command specification on IEEE1394 is standardized by 1394TA (Trade Association), and a command to realize an exclusive control is defined in “AV/C Digital Interface Command Set General Specification Version 4.2”. In this command, the priority is set, and it is considered to an execute exclusive control in accordance with the priority.

In a conventional car AV (Audio Video) system, an interruption signal (guide information and/or emergency information) from a car navigation apparatus in inputted to a H/U (Head Unit), and thereafter the transmitting signal is switched to the interruption signal. Then, the interruption signal is transferred to the amplifier to be reproduced for several to several tens seconds, and the H/U switches to the original reproducing signal to continue the reproduction. Namely, complete processing is executed in the H/U which controls the audio source.

In the car AV system, a front monitor (hereinafter referred to as “F-monitor”) and a rear monitor (hereinafter referred to as “R-monitor”) employ HMI (Human Machine Interface), and function as a controller for controlling the car AV system. When a user watches DVD by the F-monitor, the controller (control apparatus) of the F-monitor selects the DVD as a video transmitting apparatus, selects the F-monitor as the video receiving apparatus, selects the DVD as the audio transmitting apparatus and selects the amplifier as the audio receiving apparatus. Then, the controller of the F-monitor establishes the connections to transmit the video signal and the audio signal to each of the apparatuses.

In a case that the receiving apparatus of the interruption signal can have a plurality of input plugs for the interruption signal and the AV signals, if there occurs a condition to reproduce the interruption signal during the reproduction of the AV signals to watch DVD, there is no problem because the connections for transmitting the AV signals can be maintained as they are.

However, there is a case that only one logical input plug can be prepared for the interruption signal and the AV signals due to the restriction of the hardware resource. In this case, when there occurs a situation that the car navigation apparatus transmits the interruption signal (guide information and/or emergency information), the car navigation apparatus voluntarily transmits the request to establish the audio connection to the amplifier serving as the receiving apparatus, and switches the connection. However, if the amplifier already has a connection, the controller which established the connection can know by the operation apparatus state monitoring that the input audio to the amplifier is switched, but cannot determine whether it is the audio switching by the user operation from other controller or the switching due to the reproduction of the interruption signal. Therefore, if the connection is switched like a normal source switching, there occurs such a problem that the reproduction source before the reproduction of the interruption signal cannot be recovered.

The patent Reference-1 discloses a method of preventing a such harmful influence caused by switching the connection that the user's intended operation cannot be performed due to the control command from other control apparatus during the control such as the recording/reproduction by a digital TV, in a system in which the digital TV serves as the control apparatus and a DVHS serves as a controlled apparatus. However, the patent Reference-1 discloses the method of preventing the harmful influence by the exclusive control to the controlled apparatus, and its problem is different from the problem of the present invention.

Patent Reference 1:

Japanese Patent Application Laid-open under No. 2003-87262

### DISCLOSURE OF INVENTION

### Problem to be Solved by the Invention

The above is one example of the problems to be solved by the present invention. It is an object of the present invention to provide an information processing apparatus capable of recovering the original connection after the reproduction of the interruption signal, based on the pre-reproduction connection information, by retaining the pre-reproduction connection information relating to the connection existing before the reproduction of the interruption signal, when the connection is switched to reproduce the interruption signal.

### Means for Solving the Problem

The invention of claim 1 is an information processing apparatus for a car AV system including a transmitting apparatus which transmits a signal, and a receiving apparatus which is connected to the transmitting apparatus via a network and which reproduces the signal, the apparatus comprising: a pre-reproduction connection information retaining means which retains information relating to the transmitting apparatus and the receiving apparatus of a connection existing before a reproduction of an interruption signal, as pre-reproduction connection information, when the connection between the transmitting apparatus and the receiving apparatus is switched to the connection for transmitting the interruption signal in order to reproduce the interruption signal; and a recovering means which recovers the connection existing before the reproduction of the interruption signal, based on the pre-reproduction connection information, after the reproduction of the interruption signal ends.

The invention of claim 3 is a receiving apparatus, connected to a transmitting apparatus which transmits a signal, for reproducing the signal, comprising: a reproduction start notification receiving means which receives an interruption signal reproduction start notification indicating that a connection between the transmitting apparatus and the receiving apparatus is switched to a connection for transmitting the interruption signal in order to reproduce the interruption signal; a pre-reproduction connection information retaining means which retains information relating to the transmitting apparatus and the receiving apparatus of the connection existing before a reproduction of the interruption signal, as pre-reproduction connection information, when receiving the interruption signal reproduction start notification; a reproduction end notification receiving means which receives, from the transmitting apparatus, an interruption signal reproduction end notification indicating that the reproduction of the interruption signal ends; and a recovering means which recovers the connection existing before the reproduction of the interruption signal, based on the pre-reproduction connection information, when receiving the interruption signal reproduction end notification.

The invention of claim 5 is a transmitting apparatus, connected to a receiving apparatus which reproduces a signal, for transmitting the signal, comprising: a connection state confirmation request transmitting means which transmits, to the receiving apparatus, a connection state confirmation request to confirm a connection state, when the connection between the transmitting apparatus and the receiving apparatus is switched to the connection for transmitting the interruption signal in order to reproduce the interruption signal; a connection state confirmation response receiving means which receives, from the receiving apparatus, a connection state confirmation response indicating the connection state; a pre-reproduction connection information retaining means which retains information relating to the transmitting apparatus and the receiving apparatus of the connection existing before a reproduction of the interruption signal, as pre-reproduction connection information, based on the connection state confirmation response; and a recovering means which recovers the connection existing before the reproduction of the interruption signal, based on the pre-reproduction connection information, after the reproduction of the interruption signal ends.

The invention of claim 7 is a control apparatus for a car AV system comprising: a transmitting apparatus which transmits a signal; and a receiving apparatus which is connected to the transmitting apparatus via a network and which reproduces the signal, the transmitting apparatus and the receiving apparatus functioning as a control apparatus to control a connection between the transmitting apparatus and the receiving apparatus, the control apparatus comprising: a reproduction start notification receiving means which receives, from the transmitting apparatus, an interruption signal reproduction start notification indicating that the connection between the transmitting apparatus and the receiving apparatus is switched to the connection for transmitting the interruption signal, in order to transmit the interruption signal; a pre-reproduction connection information retaining means which retains information relating to the transmitting apparatus and the receiving apparatus of the connection existing before the reproduction of the interruption signal and controlled by the control apparatus, as pre-reproduction connection information, when receiving the interruption signal reproduction start notification; a reproduction end notification receiving means which receives, from the transmitting apparatus, an interruption signal reproduction end notification indicating that the reproduction of the interruption signal ends; and a recovering means which recovers the connection existing before the reproduction of the interruption signal, based on the pre-reproduction connection information, when receiving the interruption signal reproduction end notification.

The invention of claim 9 is a control program executed by a computer in a car AV system including a transmitting apparatus which transmits a signal, and a receiving apparatus which is connected to the transmitting apparatus via a network and which reproduces the signal, the program makes the computer function as: a pre-reproduction connection information retaining means which retains information relating to the transmitting apparatus and the receiving apparatus of a connection existing before a reproduction of an interruption signal, as pre-reproduction connection information, when the connection between the transmitting apparatus and the receiving apparatus is switched to the connection for transmitting the interruption signal in order to reproduce the interruption signal; and a recovering means which recovers the connection existing before the reproduction of the interruption signal, based on the pre-reproduction connection information, after the reproduction of the interruption signal ends.

The invention of claim 10 is a control program executed by a receiving apparatus, connected to a transmitting apparatus which transmits a signal, for reproducing the signal, the program making the receiving apparatus function as: a reproduction start notification receiving means which receives an interruption signal reproduction start notification indicating that a connection between the transmitting apparatus and the receiving apparatus is switched to a connection for transmitting the interruption signal in order to reproduce the interruption signal; a pre-reproduction connection information retaining means which retains information relating to the transmitting apparatus and the receiving apparatus of the connection existing before a reproduction of the interruption signal, as pre-reproduction connection information, when receiving the interruption signal reproduction start notification; a reproduction end notification receiving means which receives, from the transmitting apparatus, an interruption signal reproduction end notification indicating that the reproduction of the interruption signal ends; and a recovering means which recovers the connection existing before the reproduction of the interruption signal, based on the pre-reproduction connection information, when receiving the interruption signal reproduction end notification.

The invention of claim 11 is a control program executed by a transmitting apparatus, connected to a receiving apparatus which reproduces a signal, for transmitting the signal, the program making the transmitting apparatus function as: a connection state confirmation request transmitting means which transmits, to the receiving apparatus, a connection state confirmation request to confirm a connection state, when the connection between the transmitting apparatus and the receiving apparatus is switched to the connection for transmitting the interruption signal in order to reproduce the interruption signal; a connection state confirmation response receiving means which receives, from the receiving apparatus, a connection state confirmation response indicating the connection state; a pre-reproduction connection information retaining means which retains information relating to the transmitting apparatus and the receiving apparatus of the connection existing before a reproduction of the interruption signal, as pre-reproduction connection information, based on the connection state confirmation response; and a recovering means which recovers the connection existing before the reproduction of the interruption signal, based on the pre-reproduction connection information, after the reproduction of the interruption signal ends.

The invention of claim 12 is a control program executed by a control apparatus for a car AV system comprising: a transmitting apparatus which transmits a signal; and a receiving apparatus which is connected to the transmitting apparatus via a network and which reproduces the signal, the transmitting apparatus and the receiving apparatus functioning as a control apparatus to control a connection between the transmitting apparatus and the receiving apparatus, the program making the control apparatus function as: a reproduction start notification receiving means which receives, from the transmitting apparatus, an interruption signal reproduction start notification indicating that the connection between the transmitting apparatus and the receiving apparatus is switched to the connection for transmitting the interruption signal, in order to transmit the interruption signal; a pre-reproduction connection information retaining means which retains information relating to the transmitting apparatus and the receiving apparatus of the connection existing before the reproduction of the interruption signal and controlled by the control apparatus, as pre-reproduction connection information, when receiving the interruption signal reproduction start notification; a reproduction end notification receiving means which receives, from the transmitting apparatus, an interruption signal reproduction end notification indicating that the reproduction of the interruption signal ends; and a recovering means which recovers the connection existing before the reproduction of the interruption signal, based on the pre-reproduction connection information, when receiving the interruption signal reproduction end notification.

### BRIEF DESCRIPTION OF THE DRAWINGS

FIG. 1 is adiagramshowingan outline of IEEE1394 associated standard.

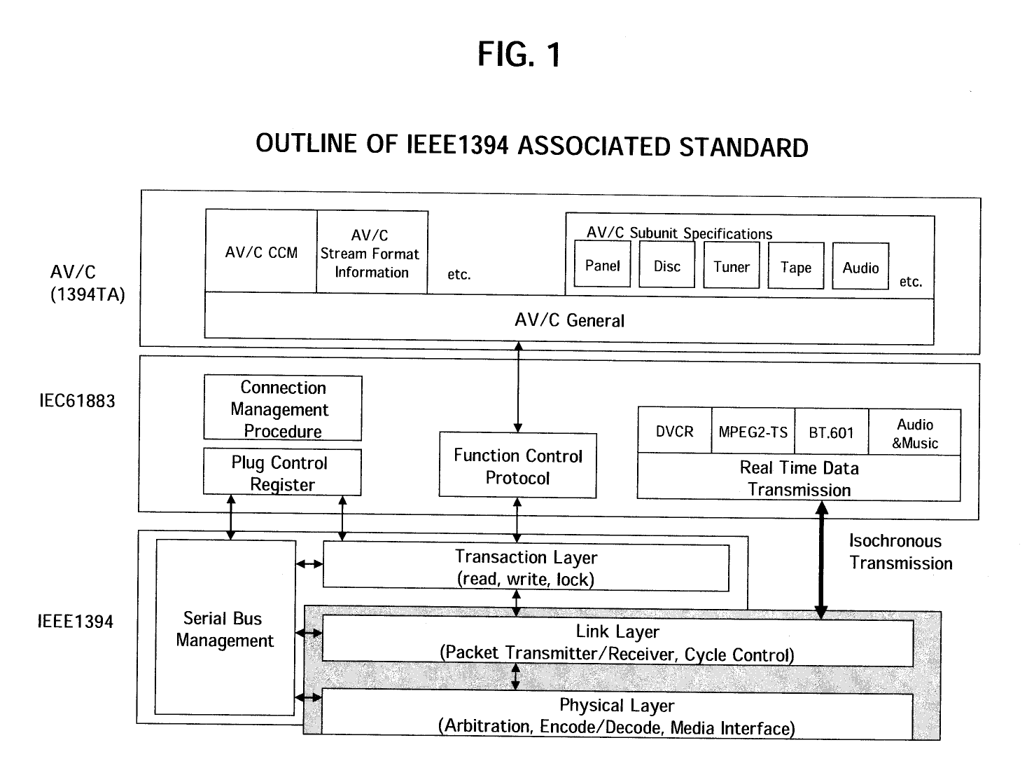

FIG. 2 is a diagram showing a configuration of CMP of IEC61883.

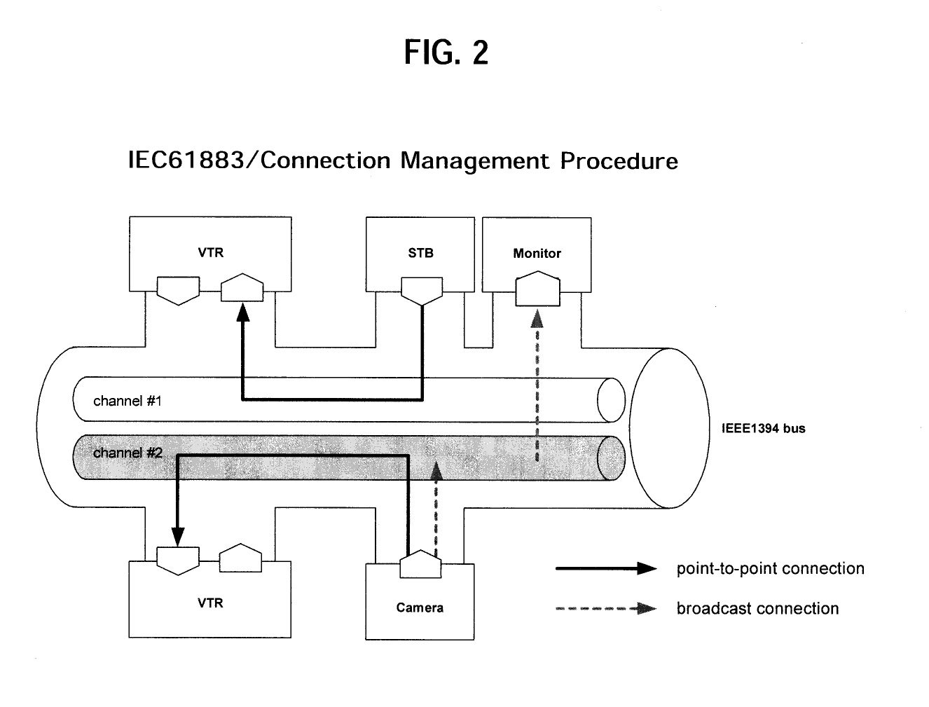

FIG. 3 is a diagram showing an example of a configuration of a car AV system according to an embodiment.

FIG. 4 is a block diagram showing a functional configuration of a receiving apparatus control unit.

FIG. 5 is a sequence diagram of a recovering process in the car AV system of the first embodiment.

FIG. 6 is a flowchart of the recovering process of the first embodiment.

FIG. 7 is a flowchart of the recovering process of the first embodiment.

FIG. 8 is a flowchart of the recovering process of the first embodiment.

FIG. 9 is a block diagram showing a functional configuration of a transmitting apparatus control unit.

FIG. 10 is a sequence diagram of a recovering process in the car AV system of the second embodiment.

FIG. 11 is a flowchart of the recovering process of the second embodiment.

FIG. 12 is a flowchart of the recovering process of the second embodiment.

FIG. 13 is a flowchart of the recovering process of the second embodiment.

FIG. 14 is a flowchart of the connection process in the second embodiment.

FIG. 15 is a block diagram showing a functional configuration of a control apparatus control unit.

FIG. 16 is a sequence diagram of a recovering process in the car AV system of the third embodiment.

FIG. 17 is a flowchart of the recovering process of the third embodiment.

### DESCRIPTION OF REFERENCE NUMBERS

1 Car AV System
10 System Bus
11 Front Monitor
12 DVD Player
13 Car Navigation Apparatus
14 DTV
15, 16 Rear Monitor
17 Amplifier
18 Speaker

### MOST PREFERRED FORM TO EXERCISE THE INVENTION

According to one aspect of the present invention, there is provided an information processing apparatus for a car AV system including a transmitting apparatus which transmits a signal, and a receiving apparatus which is connected to the transmitting apparatus via a network and which reproduces the signal, the apparatus comprising: a pre-reproduction connection information retaining means which retains information relating to the transmitting apparatus and the receiving apparatus of a connection existing before a reproduction of an interruption signal, as pre-reproduction connection information, when the connection between the transmitting apparatus and the receiving apparatus is switched to the connection for transmitting the interruption signal in order to reproduce the interruption signal; and a recovering means which recovers the connection existing before the reproduction of the interruption signal, based on the pre-reproduction connection information, after the reproduction of the interruption signal ends.

In the information processing apparatus configured as described above, a pre-reproduction connection information retaining means retains pre-reproduction connection information relating to a connection existing before the reproduction of the interruption signal, when the connection is switched to the connection for transmitting the interruption signal in order to transmit the interruption signal. Then, the recovering means recovers the connection existed before the reproduction of the interruption signal, based on the pre-reproduction connection information retained, after the reproduction of the interruption signal ends. The information processing apparatus is a transmitting apparatus and/or a receiving apparatus forming a car AV system. By this, even in a case that only one logical input plug can be prepared due to the restriction of the hardware resource, the information processing apparatus can recover the connection, after the reproduction of the interruption signal ends, with keeping the user unconscious.

One mode of the above information processing apparatus further comprises: a temporarily stopping means which executes a control of temporarily stopping an AV source which is reproduced by transmitting the signal by the connection existing before the reproduction of the interruption signal, when the connection between the transmitting apparatus and the receiving apparatus is switched to the connection for transmitting the interruption signal in order to reproduce the interruption signal. By this, the reproduction of the AV source is temporarily stopped at the time of reproducing the interruption signal, the user does not miss listening to the AV source during the reproduction of the interruption signal.

According to another aspect of the present invention, there is provided a receiving apparatus, connected to a transmitting apparatus which transmits a signal, for reproducing the signal, comprising: a reproduction start notification receiving means which receives an interruption signal reproduction start notification indicating that a connection between the transmitting apparatus and the receiving apparatus is switched to a connection for transmitting the interruption signal in order to reproduce the interruption signal; apre-reproduction connection information retaining means which retains information relating to the transmitting apparatus and the receiving apparatus of the connection existing before a reproduction of the interruption signal, as pre-reproduction connection information, when receiving the interruption signal reproduction start notification; a reproduction end notification receiving means which receives, from the transmitting apparatus, an interruption signal reproduction end notification indicating that the reproduction of the interruption signal ends; and a recovering means which recovers the connection existing before the reproduction of the interruption signal, based on the pre-reproduction connection information, when receiving the interruption signal reproduction end notification.

In the receiving apparatus configured as described above, the reproduction start notification receiving means receives the interruption signal reproduction start notification from the transmitting apparatus which transmits the interruption signal. Then, the pre-reproduction connection information retaining means retains the pre-reproduction connection information relating to the connection existing before the reproduction of the interruption signal. When the reproduction end notification receiving means receives the interruption signal reproduction end notification from the transmitting apparatus, the recovering means recovers the connection existed before the reproduction of the interruption signal based on the pre-reproduction connection information retained. As described above, the transmitting apparatus transmitting the interruption signal notifies the start and the end of the reproduction of the interruption signal to the receiving apparatus in advance, when it becomes necessary to reproduce the interruption signal on the network. Therefore, the receiving apparatus can recognize the reproduction of the interruption signal in advance, and can retain the pre-reproduction connection information necessary to switch the connection after the reproduction of the interruption signal. Based on the pre-reproduction connection information, the receiving apparatus can recover the connection existed before the reproduction of the interruption signal, after the reproduction of the interruption signal, with keeping the user unconscious.

Another mode of the above receiving apparatus further comprises: an exclusive control means which exclusively controls the receiving apparatus to exclude an intervention by other apparatus, after receiving the interruption signal reproduction end notification until the connection existing before the reproduction of the interruption signal is recovered. In this way, by excluding other connection establishment request from other apparatus after the reproduction of the interruption signal until the original connection is recovered, it can be prevented that the recovery of the original connection becomes impossible.

According to still another aspect of the present invention, there is provided a transmitting apparatus, connected to a receiving apparatus which reproduces a signal, for transmitting the signal, comprising: a connection state confirmation request transmitting means which transmits, to the receiving apparatus, a connection state confirmation request to confirm a connection state, when the connection between the transmitting apparatus and the receiving apparatus is switched to the connection for transmitting the interruption signal in order to reproduce the interruption signal; a connection state confirmation response receiving means which receives, from the receiving apparatus, a connection state confirmation response indicating the connection state; a pre-reproduction connection information retaining means which retains information relating to the transmitting apparatus and the receiving apparatus of the connection existing before a reproduction of the interruption signal, as pre-reproduction connection information, based on the connection state confirmation response; and a recovering means which recovers the connection existing before the reproduction of the interruption signal, based on the pre-reproduction connection information, after the reproduction of the interruption signal ends.

In the transmitting apparatus configured as described above, when the connection is switched in order to reproduce the interruption signal, the connection state confirmation request transmitting means transmits, to the receiving apparatus which is the receiver of the interruption signal, the connection state confirmation request to confirm the connection state at that time. Then, the connection state confirmation response receiving means receives, from the receiving means, the connection state confirmation response indicating the connection state. Then, the pre-reproduction connection information retaining means retains the pre-reproduction connection information relating to the connection existing before the reproduction of the interruption signal, based on the connection state confirmation response. Then, the recovering means recovers the connection existing before the reproduction of the interruption signal, based on the pre-reproduction connection information, after the reproduction of the interruption signal ends. By this, the transmitting apparatus which transmits the interruption signal recovers the connection existed before the reproduction of the interruption signal. Since the transmission, the reproduction start and the reproduction end of the interruption signal is managed by the transmitting apparatus, the transmitting apparatus can easily recognize the reproduction state of the interruption signal. Therefore, the transmitting apparatus can recover the connection at an appropriate timing based on the reproduction state.

One mode of the above transmitting apparatus further comprises an exclusive control means which exclusively controls the receiving apparatus to exclude an intervention by other apparatus, wherein the exclusive control means exclusively controls the receiving apparatus before the connection state confirmation request is transmitted until the connection existing before the reproduction of the interruption signal is recovered. By this, the transmitting apparatus controls such that the time interval until the original connection is re-established becomes the exclusive time period. Therefore, it can be prevented that the recovery of the original connection becomes impossible, by the intervention by other apparatus.

According to still another aspect of the present invention, there is provided a control apparatus for a car AV system comprising: a transmitting apparatus which transmits a signal; and a receiving apparatus which is connected to the transmitting apparatus via a network and which reproduces the signal, the transmitting apparatus and the receiving apparatus functioning as a control apparatus to control a connection between the transmitting apparatus and the receiving apparatus, the control apparatus comprising: a reproduction start notification receiving means which receives, from the transmitting apparatus, an interruption signal reproduction start notification indicating that the connection between the transmitting apparatus and the receiving apparatus is switched to the connection for transmitting the interruption signal, in order to transmit the interruption signal; a pre-reproduction connection information retaining means which retains information relating to the transmitting apparatus and the receiving apparatus of the connection existing before the reproduction of the interruption signal and controlled by the control apparatus, as pre-reproduction connection information, when receiving the interruption signal reproduction start notification; a reproduction end notification receiving means which receives, from the transmitting apparatus, an interruption signal reproduction end notification indicating that the reproduction of the interruption signal ends; and a recovering means which recovers the connection existing before the reproduction of the interruption signal, based on the pre-reproduction connection information, when receiving the interruption signal reproduction end notification.

In the control apparatus configured as described above, when the connection is switched in order to reproduce the interruption signal, the reproduction start notification receiving means receives the interruption signal reproduction start notification from the transmitting apparatus transmitting the interruption signal. Then, the pre-reproduction connection information retaining means retains the information relating to the connection existing before the reproduction of the interruption signal and established by the control apparatus, as the pre-reproduction control connection information. Then, when the reproduction end notification receiving means receives the interruption signal reproduction end notification from the transmitting apparatus, the recovering means recovers the connection existed before the reproduction of the interruption signal, based on the pre-reproduction connection information retained. In this way, when the reproduction of the interruption signal becomes necessary, the transmitting apparatus notifies the start and the end of the reproduction of the interruption signal, in advance, to the control apparatus. Therefore, the control apparatus can recognize the reproduction of the interruption signal in advance, and can retain the pre-reproduction connection information necessary for the connection switching after the reproduction of the interruption signal. Based on the pre-reproduction connection information, the control apparatus can recover the connection existed before the reproduction of the interruption signal, with keeping the user unconscious.

In one mode of the above control apparatus, the recovering means recovers the connection existing before the reproduction of the interruption signal, based on the pre-reproduction connection information, within a predetermined time period after receiving the interruption signal reproduction end notification, and the control apparatus does not execute a connection operation other than the connection operation by the recovering means until the connection existing before the reproduction of the interruption signal is recovered by the recovering means. In this way, each of the control apparatuses does not execute the connection operation after the reproduction of the interruption signal until the control apparatus which should recover the original connection executes the recovering process. The control apparatus which should recover the original connection executes the connection recovery within a predetermined time (e.g., 1 second) after receiving the interruption signal reproduction end notification. By this, it can be prevented that the recovery of the original connection becomes impossible.

According to still another aspect of the present invention, there is provided a control program executed by a computer in a car AV system including a transmitting apparatus which transmits a signal, and a receiving apparatus which is connected to the transmitting apparatus via a network and which reproduces the signal, the program makes the computer function as: a pre-reproduction connection information retaining means which retains information relating to the transmitting apparatus and the receiving apparatus of a connection existing before a reproduction of an interruption signal, as pre-reproduction connection information, when the connection between the transmitting apparatus and the receiving apparatus is switched to the connection for transmitting the interruption signal in order to reproduce the interruption signal; and a recovering means which recovers the connection existing before the reproduction of the interruption signal, based on the pre-reproduction connection information, after the reproduction of the interruption signal ends. By executing the above control program, it is possible to recover the connection, after the reproduction of the interruption signal, with keeping the user unconscious. This control program may be appropriately handled in the state recorded on a storage medium.

According to still another aspect of the present invention, there is provided a control program executed by a receiving apparatus, connected to a transmitting apparatus which transmits a signal, for reproducing the signal, the program making the receiving apparatus function as: a reproduction start notification receiving means which receives an interruption signal reproduction start notification indicating that a connection between the transmitting apparatus and the receiving apparatus is switched to a connection for transmitting the interruption signal in order to reproduce the interruption signal; apre-reproduction connection information retaining means which retains information relating to the transmitting apparatus and the receiving apparatus of the connection existing before a reproduction of the interruption signal, as pre-reproduction connection information, when receiving the interruption signal reproduction start notification; a reproduction end notification receiving means which receives, from the transmitting apparatus, an interruption signal reproduction end notification indicating that the reproduction of the interruption signal ends; and a recovering means which recovers the connection existing before the reproduction of the interruption signal, based on the pre-reproduction connection information, when receiving the interruption signal reproduction end notification. By executing the above control program, it is possible to recover the connection, after the reproduction of the interruption signal, with keeping the user unconscious. This control program may be appropriately handled in the state recorded on a storage medium.

According to still another aspect of the present invention, there is provided a control program executed by a transmitting apparatus, connected to a receiving apparatus which reproduces a signal, for transmitting the signal, the program making the transmitting apparatus function as: a connection state confirmation request transmitting means which transmits, to the receiving apparatus, a connection state confirmation request to confirm a connection state, when the connection between the transmitting apparatus and the receiving apparatus is switched to the connection for transmitting the interruption signal in order to reproduce the interruption signal; a connection state confirmation response receiving means which receives, from the receiving apparatus, a connection state confirmation response indicating the connection state; a pre-reproduction connection information retaining means which retains information relating to the transmitting apparatus and the receiving apparatus of the connection existing before a reproduction of the interruption signal, as pre-reproduction connection information, based on the connection state confirmation response; and a recovering means which recovers the connection existing before the reproduction of the interruption signal, based on the pre-reproduction connection information, after the reproduction of the interruption signal ends. By executing the above control program, it is possible to recover the connection, after the reproduction of the interruption signal, with keeping the user unconscious. This control program may be appropriately handled in the state recorded on a storage medium.

According to still another aspect of the present invention, there is provided a control program executed by a control apparatus for a car AV system comprising: a transmitting apparatus which transmits a signal; and a receiving apparatus which is connected to the transmitting apparatus via a network and which reproduces the signal, the transmitting apparatus and the receiving apparatus functioning as a control apparatus to control a connection between the transmitting apparatus and the receiving apparatus, the program making the control apparatus function as: a reproduction start notification receiving means which receives, from the transmitting apparatus, an interruption signal reproduction start notification indicating that the connection between the transmitting apparatus and the receiving apparatus is switched to the connection for transmitting the interruption signal, in order to transmit the interruption signal; a pre-reproduction connection information retaining means which retains information relating to the transmitting apparatus and the receiving apparatus of the connection existing before the reproduction of the interruption signal and controlled by the control apparatus, as pre-reproduction connection information, when receiving the interruption signal reproduction start notification; a reproduction end notification receiving means which receives, from the transmitting apparatus, an interruption signal reproduction end notification indicating that the reproduction of the interruption signal ends; and a recovering means which recovers the connection existing before the reproduction of the interruption signal, based on the pre-reproduction connection information, when receiving the interruption signal reproduction end notification. By executing the above control program, it is possible to recover the connection, after the reproduction of the interruption signal, with keeping the user unconscious. This control program may be appropriately handled in the state recorded on a storage medium.

### EMBODIMENT

Preferred embodiments of the present invention will be described below with reference to the attached drawings.

[Car AV System]

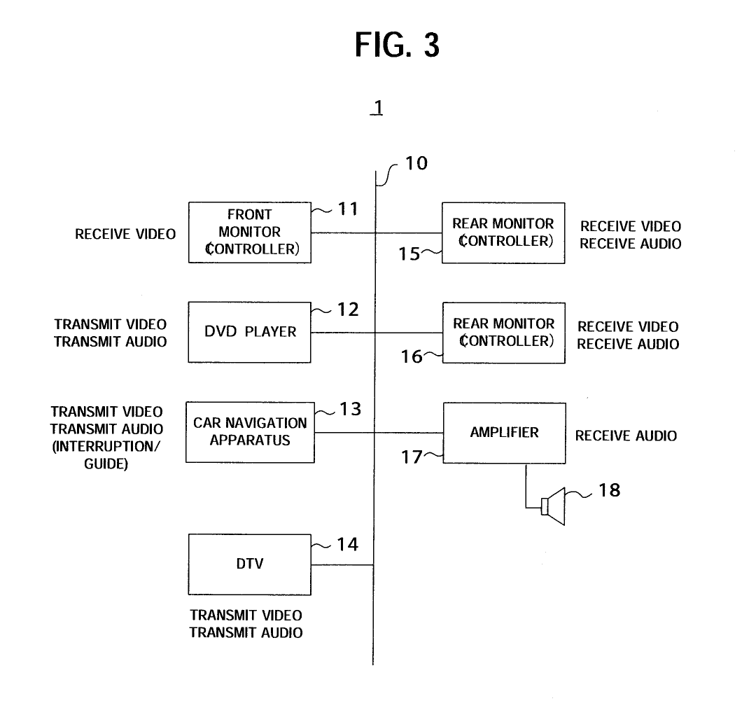

First, a configuration and prerequisites of a car AV (Audio Video) system 1 will be described with reference to FIG. 3. FIG. 3 is a diagram showing an example of a configuration of a car AV system 1 according to an embodiment of the present invention.

As shown in FIG. 3, the car AV system 1 includes a front monitor (hereinafter referred to as “F-monitor”) 11, a DVD player 12, a car navigation apparatus 13, a DTV (Digital TeleVison) 14, a rear monitor (hereinafter referred to as “R-monitor) 15, a R-monitor 16 and an amplifier 17, which are connected to each other via a system bus 10.

The F-monitor 11 is a video receiving apparatus which displays video on a display based on various video signals received from a video transmitting apparatus. The F-monitor 11 includes a graphic controller which performs the control of the F-monitor 11 based on the control signal transmitted from the controller (control apparatus) and the transmitting apparatus via the system bus 10, a buffer memory which is a memory such as VRAM (Video RAM) and which temporarily stores the video signal promptly displayable, a display control unit which controls the display such as an LCD and a CRT (Cathode Ray Tube) based on the video signal outputted by the graphic controller, and a display. The display may be a liquid crystal display device mounted near the front panel in the vehicle compartment.

The DVD player 12 reads out contents data such as an audio signal and a video signal from a disc such as DVD under the control of the controller, and transmits it to the video receiving apparatus. The DVD player 12 is also an audio transmitting apparatus which transmits data to an audio receiving apparatus.

The car navigation apparatus 13 utilizes a GPS, vehicle speed pulses and a stand-alone measurement device such as a gyro-sensor, and performs a guidance such as a presentation of current position and a route guidance to a destination for the user during the driving of the vehicle. The car navigation apparatus 13 is an audio transmitting apparatus having guide voice necessary for the guidance, and reads out the corresponding audio signal to transmit it to the audio receiving apparatus. Also, the car navigation apparatus 13 is a video transmitting apparatus having map data necessary for the guidance, and reads out the corresponding video signal to transmit it to the video receiving apparatus. The car navigation apparatus 13 sometimes transmits guide voice to the receiving apparatus as an interruption signal. For example, when the receiving apparatus is reproducing the AV signal received from the DVD player 12, if it receives the interruption signal, it reproduces and outputs the corresponding voice by interruption.

The DTV 14 is an apparatus which receives a television broadcasting using a digital modulation and a digital compression (e.g., the terrestrial digital broadcasting in Japan). In the car AV system 1, the DTV 14 is an apparatus which transmits the audio signal of the received television broadcasting to the audio receiving apparatus. Also, the DTV 14 is a video transmitting apparatus which transmits the video signal of the received television broadcasting to the video receiving apparatus.

The amplifier 17 is connected to the on-vehicle speakers 18, and is an audio receiving apparatus which outputs audio via the on-vehicle speakers 18 based on the various audio signals received from the audio transmitting apparatus. The amplifier 17 includes a D/A (Digital to Analog) converter which performs the D/A conversion of the audio signal received via the system bus 10, under the control of the controller, and an amplifier which amplifies the audio analog signal outputted from the D/A converter.

The R-monitors 15 and 16 are the video receiving apparatuses like the F-monitor 11, but are mounted on the rear area of the vehicle compartment. Also, the R-monitors 15 and 16 function as the audio receiving apparatus like the amplifier 17.

The F-monitor 11 and the R-monitors 15 and 16 have a HMI (Human Machine Interface) such as a touch-panel and buttons, and function as controllers to control the car AV system 1. The controller basically exists in the monitors and a H/U (Head Unit). While the controllers are the F-monitor 11 and the R-monitors 15 and 16 in this embodiment, the present invention is not limited to this. The apparatus which functions as a controller may be arbitrarily set.

Each of the controller and the transmitting apparatus can operate independently, and performs the recognition of the apparatuses on the network (system bus), the connection management of the apparatus subjected to the operation of the controller itself, the apparatus control, and the monitoring of the operation state of the apparatuses on the network. On the network, there are plural controllers which establish the connection between the apparatuses. Therefore, it is possible that the F-monitor 11 functions as the controller and selects the watching and listening source of the R-monitor 15, for example. The controller ensures an operationability like a remote controller, and has a “last-one-win” character that the last operation is valid.

As described above, according to the car AV system 1 of this embodiment, a plurality of apparatuses including the video transmitting apparatus, the audio transmitting apparatus, the video receiving apparatus and the audio receiving apparatus exist in a mixed manner on the network. In other words, the video transmitting apparatus, the audio transmitting apparatus, the video receiving apparatus and the audio receiving apparatus are connected via the network. The apparatus such as the car navigation apparatus 13 which outputs the interruption signal to the network and the apparatus such as the DVD player 12 which outputs the AV signals of DVD and/or CD to the network are configured as different apparatuses.

It is assumed that the video signal and the audio signal are transmitted separately. Each of the video signal and the audio signal may be inputted to the video receiving apparatus and the audio receiving apparatus (e.g., the F-monitor 11 and the amplifier 17), different from each other, and may be inputted to the same apparatus (e.g., the R-monitor 15).

In addition, in order to transmit the audio signal on the network, it is necessary to establish a logical connection between the audio transmitting apparatus and the audio receiving apparatus. The connection must be switched if the transmitting apparatuses are different.

### 1st Embodiment

In the first embodiment, when the connection is switched for the reproduction of the interruption signal, the receiving apparatus which reproduces the interruption signal retains pre-reproduction connection information related to the connection existing before the interruption signal reproduction, and recovers the original connection after the end of the interruption signal reproduction, based on the pre-reproduction connection information.

(i) Receiving Apparatus Control Unit

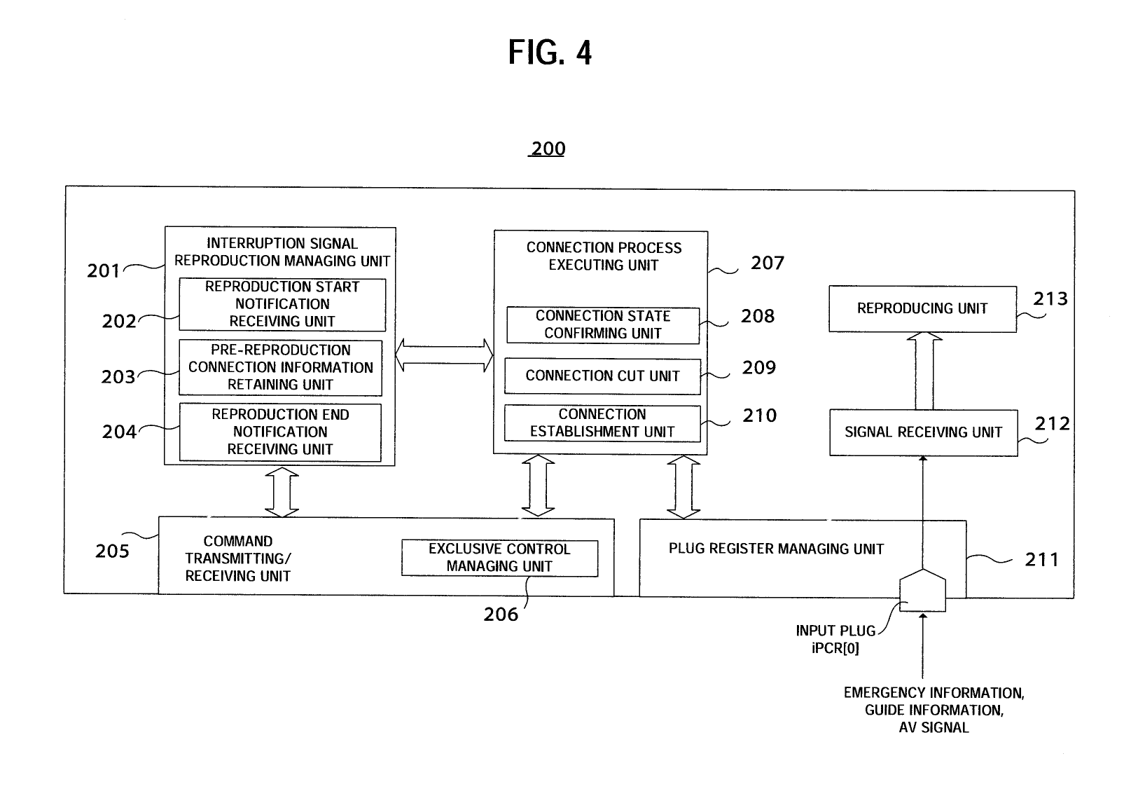

First, the receiving apparatus control unit 200 configured by the constitutional elements of the receiving apparatus will be described with reference to FIG. 4. FIG. 4 is a block diagram of the receiving apparatus control unit 200.

The receiving apparatus control unit 200 retains the pre-reproduction connection information related to the connection existing before the interruption signal reproduction, and re-establishes the original connection after the end of the interruption signal reproduction based on the pre-reproduction connection information.

As shown in FIG. 4, the receiving apparatus control unit 200 includes an interruption signal reproduction managing unit 201, a reproduction start notification receiving unit 202, a pre-reproduction connection information retaining unit 203, a reproduction end notification receiving unit 204, a command transmitting/receiving unit 205, an exclusive control managing unit 206, a connection process executing unit 207, a connection state confirming unit 208, a connection cut unit 209, a connection establishment unit 210, a plug register managing unit 211, a signal receiving unit 212 and a reproducing unit 213.

The interruption signal reproduction managing unit 201 performs a management for switching the connection for reproducing the interruption signal, and includes the reproduction start notification receiving unit 202, the pre-reproduction connection information retaining unit 203 and the reproduction end notification receiving unit 204.

The reproduction start notification receiving unit 202 receives, from the transmitting apparatus which transmits the interruption signal, the interruption signal reproduction start notification indicating that the connection between the transmitting apparatus and the receiving apparatus is switched to the connection for transmitting the interruption signal, at the time of reproducing the interruption signal. The reproduction start notification receiving unit 202 functions as the reproduction start notification receiving means in the receiving apparatus of the present invention.

The pre-reproduction connection information retaining unit 203 retains information relating to the transmitting apparatus and the receiving apparatus of the connection existing before the interruption signal reproduction by storing it in a memory such as aRAMand/or a ROMas the pre-reproduction connection information, when the reproduction start notification receiving unit 202 receives the interruption signal reproduction start notification. The pre-reproduction connection information retaining unit 203 functions as the pre-reproduction connection information retaining means in the receiving apparatus of the present invention.

The reproduction end notification receiving unit 204 receives, from the transmitting apparatus which transmits the interruption signal, the interruption signal reproduction end notification indicating that the transmission (reproduction) of the interruption signal ends. The reproduction end notification receiving unit 204 functions as the reproduction end notification receivingmeans in the receiving apparatus of the present invention.

The command transmitting/receiving unit 205 transmits and receives the command to manage the interruption signal reproduction and to execute the connection process and/or the exclusive control process. Specifically, the command transmitting/receiving unit 205 receives, from the transmitting apparatus and/or the controller, the connection state confirmation request, the connection establishment request, the connection cut request, the exclusive control right setting request and the exclusive control right release request, described later. Also, the command transmitting/receiving unit 205 receives, from the transmitting apparatus which transmits the interruption signal, the interruption signal reproduction start notification and the interruption signal reproduction end notification. Also, the command transmitting/receiving unit 205 transmits, to the transmitting apparatus and/or the controller, the connection state confirmation response, the connection establishment response, the connection cut response, the exclusive control right setting response and the exclusive control right release response, described later.

The command transmitting/receiving unit 205 includes the exclusive control managing unit 206. The exclusive control managing unit 206 receives the exclusive control right setting request to exclusively control the receiving apparatuses and exclude the intervention by other apparatus, from the transmitting apparatus which transmits the interruption signal. When receiving the exclusive control right setting request, the exclusive control managing unit 206 sets the exclusive control right to the receiving apparatus. Then, the exclusive control managing unit 206 transmits, to the transmitting apparatus, the exclusive control right setting response indicating that the exclusive control right setting request is accepted and the exclusive control right is set (ACCEPTED), or that the exclusive control right setting request is rejected and the exclusive control right is not set (REJECTED). The exclusive control managing unit 206 functions as the exclusive control means in the receiving apparatus of the present invention.

Also, the exclusive control managing unit 206 receives, from the transmitting apparatus which ends the transmission of the interruption signal, the exclusive control right release request to release the set exclusive control right. When receiving the exclusive control right release request, the exclusive control managing unit 206 releases the exclusive control right set to the receiving apparatus. Then, the exclusive control managing unit 206 transmits, to the transmitting apparatus, the exclusive control right release response indicating that the exclusive control right release request is accepted and the exclusive control right is released (ACCEPTED), or that the exclusive control right release request is rejected and the exclusive control right is not released (REJECTED).

The connection process executing unit 207 executes the process to establish the connection by associating the logical input plug of the receiving apparatus and the logical output plug of the transmitting apparatus by the channel information, and to cut the connection. The connection process executing unit 207 includes the connection state confirming unit 208, the connection cut unit 209 and the connection establishment unit 210.

The connection state confirming unit 208 receives, from the transmitting apparatus and/or the controller, the connection state confirmation request to confirm the connection state. When receiving the connection state confirmation request, the connection state confirming unit 208 transmits, to the transmitting apparatus and/or the controller, the connection state confirmation response indicating the state of the connection already being established. For example, when the receiving apparatus is the amplifier 17 which has established the connection with the DTV 14, the connection state confirming unit 208 receives the connection state confirmation response indicating that the connection is being established with the DTV (e.g., “DTV-AMP”). On the contrary, when the controlled apparatus has not established the connection, the connection state confirming unit 208 receives the connection state confirmation response indicating that the connection is not being established (e.g., “NO CONNECTION”).

The connection cut unit 209 receives, from the transmitting apparatus and/or the controller, the cutting request to cut the connection. Then, the connection cut unit 209 cuts the connection designated by the connection cut request. Also, the connection cut unit transmits, to the transmitting apparatus and/or the controller which transmitted the connection cut request, the connection cut response indicating that the connection cut request is accepted and the connection is cut (ACCEPTED) or that the connection cut request is rejected and the connection is not cut (REJECTED).

The connection establishment unit 210 receives, from the transmitting apparatus and/or the controller, the connection establishment request to establish the connection. Then, the connection establishment unit 210 establishes the connection between the output plug of the transmitting apparatus designated by the connection establishment request and the input plug of the receiving apparatus. The establishment of the connection is realized by associating the logical output plug (oPCR[i]) of the transmitting apparatus with the logical input plug (iPCR[i]) of the receiving apparatus by the channel information, by using IEEE1394 transaction.

Specifically, the connection establishment unit 210 establishes the connection between the output plug of the video transmitting apparatus and the input plug of the video receiving apparatus based on the connection establishment request. Also, the connection establishment unit 210 establishes the connection between the output plug of the audio transmitting apparatus and the input plug of the audio receiving apparatus based on the connection establishment request. Further, the connection establishment unit 210 transmits, to the transmitting apparatus and/or the controller which transmits the connection establishment request, the connection establishment response indicating that the connection establishment request is accepted and the connection is established (ACCEPTED) or that the connection establishment request is rejected and the connection is not established (REJECTED). In this way, the connection establishment unit 210 establishes the connections to transmit the video signal and the audio signal, respectively, based on the connection establishment request from the transmitting apparatus and/or the controller.

Also, the connection establishment unit 210 re-establishes the connection existing before the interruption signal reproduction, based on the pre-reproduction connection information retained by the pre-reproduction connection information retaining unit 203, when the reproduction end notification receiving unit 204 receives the interruption signal reproduction end notification. In this way, the connection establishment unit 210 recovers the connection existing before the interruption signal reproduction, based on the interruption signal reproduction end notification from the transmitting apparatus which transmits the interruption signal. The connection establishment unit 210 functions as the recovering means in the receiving apparatus of the present invention.

The plug register managing unit 211 manages the input plug of the receiving apparatus. For example, since the receiving apparatus of this embodiment has only one logical input plug, the plug register managing unit 211 manages only the input plug (iPCR[0]) of the plug ID[0], as shown in FIG. 4. When the audio signal and the video signal such as the emergency information, the guide information and the AV signals are inputted, the receiving apparatus can receive various signals.

The signal receiving unit 212 receives the video signal and the audio signal inputted to the input plug from the transmitting apparatus via the connection.

The reproducing unit 213 reproduces the signals received by the signal receiving unit 212, thereby to output the audio or the video to the speaker or the display.

It is noted that the above-mentioned units are realized by the CPU of the receiving apparatus which executes the program prepared in advance.

(ii) Recovering Process by Receiving Apparatus

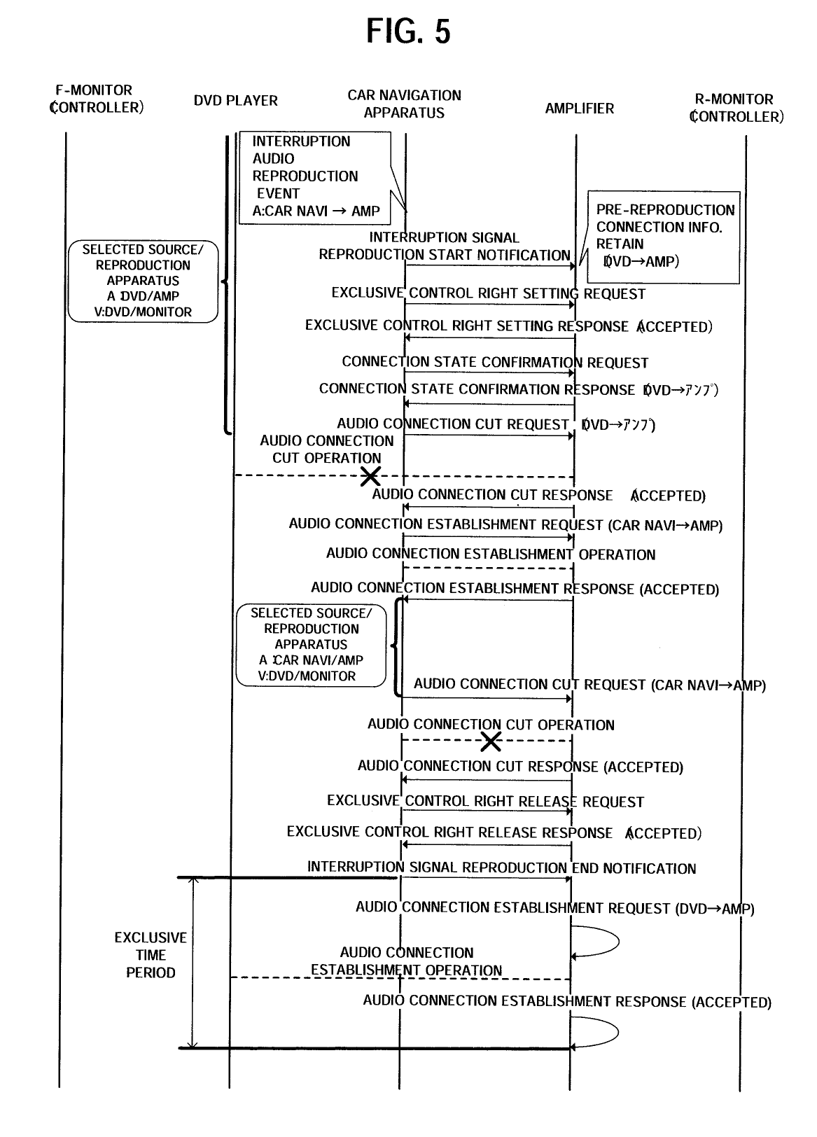

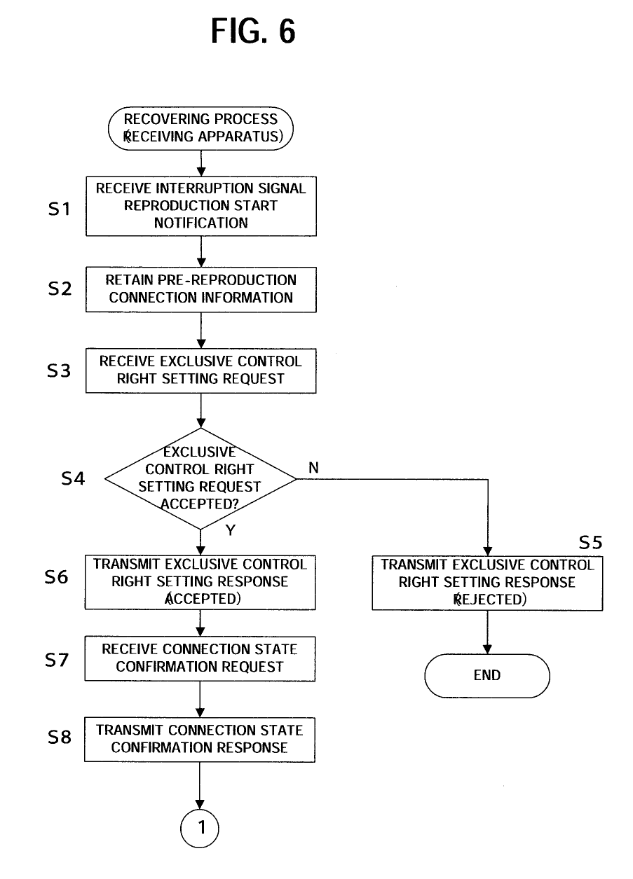

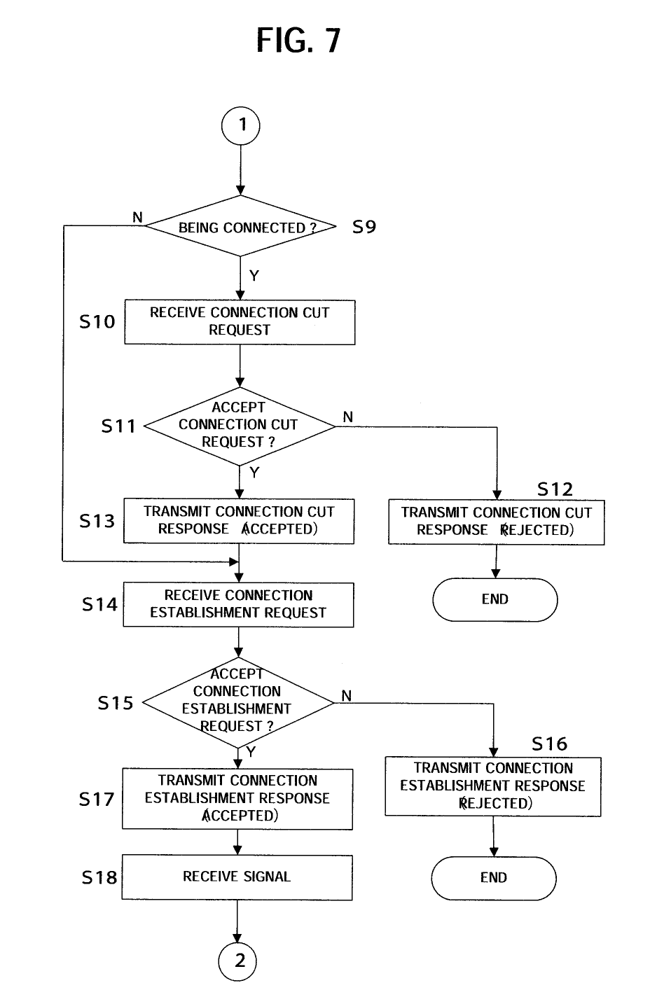

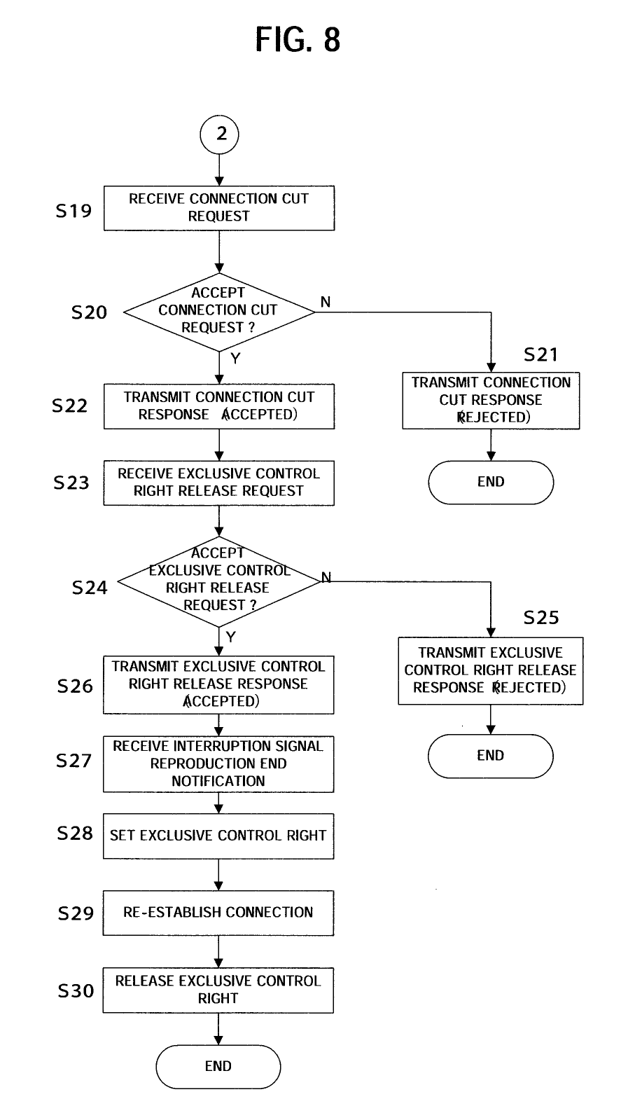

Next, the recovering process by the receiving apparatus of the embodiment will be described with reference to FIGS. 5 to 8. FIG. 5 is a sequence diagram of the recovering process by the car AV system 1. FIGS. 6 to 8 are the flowcharts of the recovering process by the receiving apparatus.

The recovering process is to retain the pre-reproduction connection information relating to the connection existing before the interruption signal reproduction, and to re-establish the original connection after the end of the interruption signal reproduction based on the pre-reproduction connection information. In this embodiment, the interruption signal transmitting apparatus is the car navigation apparatus 13, and the interruption signal receiving apparatus is the amplifier 17. The interruption signal receiving apparatus receives the audio signal of the guide voice. It is assumed that the amplifier 17 serving as the interruption signal receiving apparatus has established the audio connection with the DVD player 12 before the interruption signal reproduction. By this, the amplifier 17 interrupts the audio signal received from the DVD player 12, and receives the audio signal from the car navigation apparatus 13 to reproduce the guide voice by interruption. Then, when the reproduction of the guide voice ends, the amplifier 17 re-establishes the audio connection with the DVD player 12, and receives the audio signal from the DVD player 12 to reproduce the corresponding audio.

As shown in FIG. 5, when the interruption audio reproducing event occurs, the car navigation apparatus 13 transmits the interruption signal reproduction start notification to the amplifier 17 which is the receiver of the interruption audio. In the interruption signal receiving apparatus, i.e., the receiving apparatus control unit 200 of the amplifier 17, the reproduction start notification receiving unit 202 receives the interruption signal reproduction start notification from the transmitting apparatus transmitting the interruption signal, i.e., the car navigation apparatus 13 (step S1). Then, the pre-reproduction connection information retaining unit 203 retains the information relating to the transmitting apparatus and the receiving apparatus of the connection existing before the interruption signal reproduction, as the pre-connection information (step S2). Specifically, the pre-reproduction information includes information indicating that the connection has been established between the DVD player 12 serving as the transmitting apparatus and the amplifier 17 serving as the receiving apparatus.

Subsequently, the exclusive control managing unit 206 receives the exclusive control right setting request from the car navigation apparatus 13 (step S3). When receiving the exclusive control right setting request, the exclusive control managing unit 206 determines whether or not to accept the exclusive control right setting request and set the exclusive control right to the amplifier 17 (step S4). When rejecting the exclusive control right setting request (step S4; No), the exclusive control managing unit 206 transmits the exclusive control right setting response (REJECTED) to the car navigation apparatus 13, and ends the recovering process (step S5). On the contrary, when accepting the exclusive control right setting request (step S4; Yes), the exclusive control managing unit 206 sets the exclusive control right to exclude the intervention by other apparatus to the amplifier 17, and transmits the exclusive control right setting response (ACCEPTED) to the car navigation apparatus 13 (step S6).

The car navigation apparatus 13 which received the exclusive control right setting response (ACCEPTED) transmits the connection state confirmation request to the amplifier 17. Namely, the connection state confirming unit 208 receives the connection state confirmation response from the car navigation apparatus 13 (step S7). Then, the connection state confirming unit 208 transmits the connection state confirmation response indicating the connection state of the amplifier 17 to the car navigation apparatus 13 (step S8). Specifically, the connection state confirming unit 208 transmits the connection state confirmation response (DVD-AMP) indicating that the connection is established, i.e., being connected, between the amplifier 17 and the DVD player 12. When the amplifier 17 is not connected to other apparatus (step S9; No), the receiving apparatus control unit 200 goes to the process of step S14. On the contrary, when the amplifier 17 is connected to other apparatus (step S9; Yes), the connection cut unit 209 receives, from the car navigation apparatus 13, the connection cut request (the audio connection cut request) which is a request to cut the connection already established (step S10).

The connection cut unit 209 determines whether or not to accept the connection cut request to cut the connection already established (step S11). When rejecting the connection cut request (step S11; No), the connection cut unit 209 transmits the connection cut response (REJECTED) to the car navigation apparatus 13, and ends the recovering process (step S12). On the contrary, when accepting the connection cut request (step S11; Yes), the connection cut unit 209 cuts the connection with the DVD player 12, and transmits the connection cut response (ACCEPTED) (step S13).

The car navigation apparatus 13 transmits, to the amplifier 17, the connection establishment request (the audio connection establishment request) to establish the connection for transmitting the interruption signal. Namely, the connection establishment unit 210 receives the connection establishment request from the car navigation apparatus 13 (step S14). Then, the connection establishment unit 210 determines whether or not to accept the connection establishment request and establishes the connection with the car navigation apparatus 13 (step S15). When rejecting the connection establishment request (step S15; No), the connection establishment unit 210 transmits, to the car navigation apparatus 13, the connection establishment response (REJECTED), and ends the recovering process (step S16). On the contrary, when accepting the connection establishment request (step S15; Yes), the connection establishment unit 210 establishes the connection with the car navigation apparatus 13, and transmits the connection establishment response (ACCEPTED) (step S17).

When the connection with the car navigation apparatus 13 is established, the signal receiving unit 212 receives the audio signal of the guide voice as the interruption signal (step S18). Then, the reproducing unit 213 reproduces the received audio signal to output the guide voice from the speaker 18. When the reproduction of the interruption signal ends, the car navigation apparatus 13 transmits, to the amplifier 17, the connection cut request (the audio connection cut request) which is a request to cut the connection established to transmit the interruption signal. Namely, the connection cut unit 209 receives, from the car navigation apparatus 13, the connection cut request which is a request to cut the connection with the car navigation apparatus 13 (step S19).

The connection cut unit 209 determines whether or not to accept the connection cut request and cut the connection with the car navigation apparatus 13 (step S20). When rejecting the connection cut request (step S20; No), the connection cut unit 209 transmits the connection cut response (REJECTED) to the car navigation apparatus 13 and ends the recovering process (step S21). On the contrary, when accepting the connection cut request (step S20; Yes), the connection cut unit 209 cuts the connection with the car navigation apparatus 13, and transmits the connection cut response (ACCEPTED) (step S22).

When receiving the connection cut response (ACCEPTED), the car navigation apparatus 13 transmits the exclusive control right release request to the amplifier 17. Namely, the exclusive control right managing unit 206 receives the exclusive control right release request from the car navigation apparatus 13 (step S23). The exclusive control managing unit 206 determines whether or not to accept the exclusive control right release request and release the exclusive control right (step S24). When rejecting the exclusive control right release request (step S24; No), the exclusive control managing unit 206 transmits the exclusive control right release response (REJECTED) to the car navigation apparatus 13, and ends the recovering process (step S25). On the contrary, when accepting the exclusive control right release request (step S24; Yes), the exclusive control managing unit 206 releases the exclusive control right of the amplifier 17, and transmits the exclusive control right release response (ACCEPTED) to the car navigation apparatus 13 (step S26).

When receiving the exclusive control right release response (ACCEPTED), the car navigation apparatus 13 transmits the interruption signal reproduction end notification to the amplifier 17. Namely, the reproduction end notification receiving unit 204 receives the interruption signal reproduction end notification from the car navigation apparatus 13 (step S27). Then, the exclusive control managing unit 206 sets the exclusive control right to the amplifier 17 and excludes the intervention by other apparatus (step S28). In the state that the exclusive control right is set, the connection establishment unit 210 re-establishes the connection existed before the interruption signal reproduction, based on the pre-reproduction connection information retained by the pre-reproduction connection information retaining unit 203 (step S29). Namely, the connection establishment unit 210 recovers the connection between the amplifier 17 and the DVD player 12 by re-establishing it. When the connection is re-established, the exclusive control managing unit 206 releases the exclusive control of the amplifier 17, and ends the recovering process (step S30).

As described above, when the reproduction of the interruption signal becomes necessary on the network, the transmitting apparatus which transmits the interruption signal in this embodiment notifies the start and the end of the reproduction of the interruption signal, in advance, to the receiving apparatus. Therefore, the receiving apparatus can recognize the reproduction of the interruption signal, in advance, and can retain the pre-reproduction connection information necessary for the switching of the connection after the end of the interruption signal reproduction. Based on the pre-reproduction connection information, the receiving apparatus can recover the connection existed before the interruption signal reproduction, after the end of the interruption signal reproduction, with keeping the user unconscious.

Also, in the time period after the exclusive control right release request or the interruption signal reproduction end notification is received from the transmitting apparatus until the original connection is re-established, the receiving apparatus rejects the connection operation other than the re-establishing. Here, the connection operation includes the exclusive control right setting request accompanied with the connection establishment request. By excluding other connection establishment request from other apparatus in the time period after the reproduction of the interruption signal ends until the original connection is re-established, it can be prevented that the original connection cannot be recovered.

By executing the connection recovering process by the interruption signal receiving apparatus, the connection management can be easily performed.

### 2nd Embodiment

In the second embodiment, when the connection is switched for the interruption signal reproduction, the transmitting apparatus which transmits the interruption signal retains the pre-reproduction connection information relating to the connection existing before the interruption signal reproduction and executes the process to recover the original connection based on the pre-reproduction connection information after the interruption signal reproduction ends.

(i) Transmitting Apparatus Control Unit

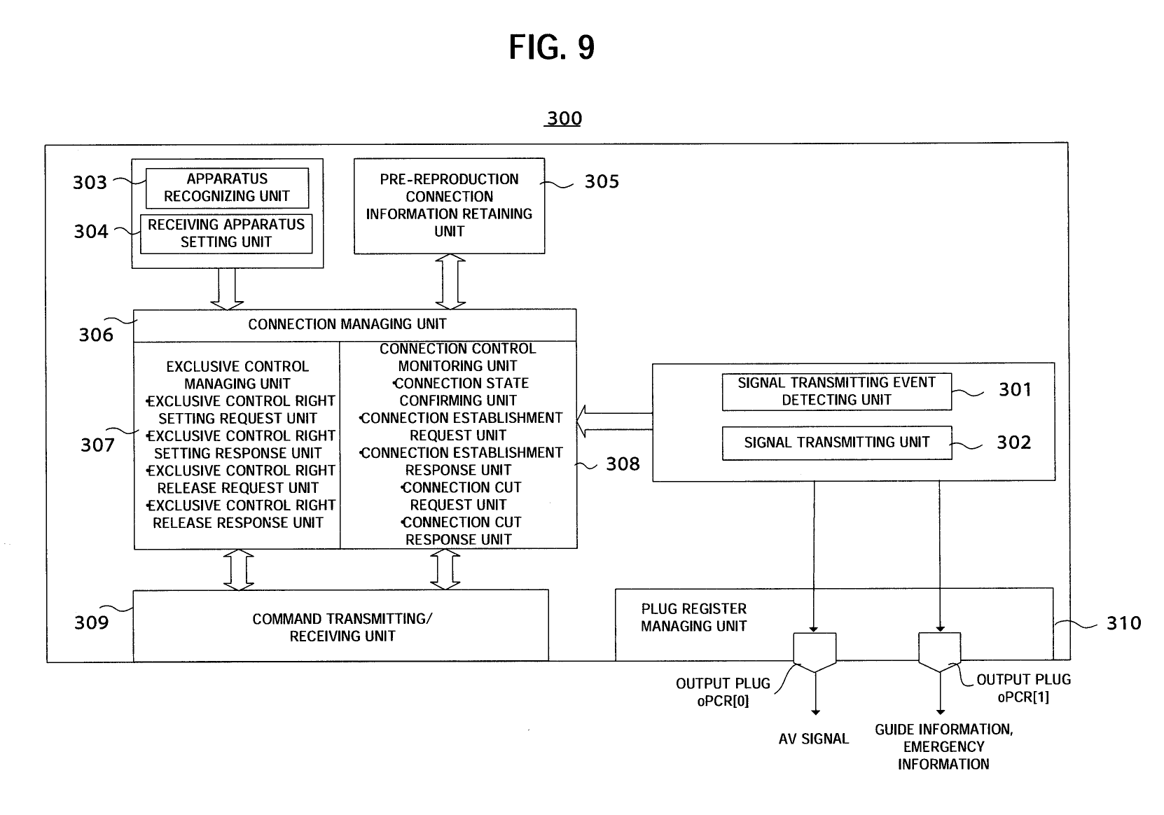

First, the transmitting apparatus control unit 300 configured by the constitutional elements of the transmitting apparatus will be described with reference to FIG. 9. FIG. 9 is a block diagram of the transmitting apparatus control unit 300.

The transmitting apparatus control unit 300 retains the pre-reproduction connection information relating to the connection existing before the interruption signal reproduction, and re-establishes the original connection after the interruption signal reproduction based on the pre-reproduction connection information after the interruption signal reproduction ends.

As shown in FIG. 9, the transmitting apparatus control unit 300 includes a signal transmitting event detecting unit 301, a signal transmitting unit 302, an apparatus recognizing unit 303, a receiving apparatus setting unit 304, a pre-reproduction connection information retaining unit 305, a connection managing unit 306, an exclusive control managing unit 307, a connection control monitoring unit 308, a command transmitting/receiving unit 309 and a plug register managing unit 310.

The signal transmitting event detecting unit 301 detects that the event to transmit the interruption signal occurs. For example, if the transmitting apparatus is the car navigation apparatus 13, the signal transmitting event detecting unit 301 detects that the event to transmit the signal occurs at the timing of transmitting the audio signal of the guide voice such as “Turn Right !”.

The signal transmittingunit 302 transmits the video signal and the audio signal to the receiving apparatus from the output plug via the connection to the input plug. Specifically, the signal transmitting unit 202 transmits the video signal and the audio signal to the receiving apparatus by the connection established by the connection managing unit 306 described later. The transmitting apparatus retains various signals by various methods such as reading out from a disc, receiving from TV broadcasting or storing in advance.

The apparatus recognizing unit 303 recognizes the apparatus to which the transmitting apparatus is being connected on the network.

The receiving apparatus setting unit 304 obtains the information relating to the receiving apparatus recognized by the apparatus recognizing unit 303, and sets the receiving apparatus to which the video signal and the audio signal are transmitted.

The pre-reproduction connection information retaining unit 305 retains the information relating to the transmitting apparatus and the receiving apparatus of the connection existing before the interruption signal reproduction, based on the connection state confirmation response received by the connection control monitoring unit 308 described later, by storing it in the memory such as a RAM and a ROM as the pre-reproduction connection information. The pre-reproduction connection information retaining unit 305 functions as the pre-reproduction connection information retaining means in the transmitting apparatus of the present invention.

The connection managing unit 306 manages the exclusive control of the receiving apparatus during the signal reproduction, and the establishment and cutting of the connection to transmit the signals. The connection managing unit 306 includes the exclusive control managing unit 307 and the connection control monitoring unit 308. The exclusive control managing unit 307 functions as the exclusive control means of the transmitting apparatus according to the present invention.

The exclusive control managing unit 307 manages the exclusive control of the receiving apparatus set by the receiving apparatus setting unit 304, and includes the exclusive control right setting request unit, the exclusive control right setting response unit, the exclusive control right release request unit and the exclusive control right release response unit.

The exclusive control right setting request unit transmits, to the receiving apparatus set by the receiving apparatus setting unit 304, the exclusive control right setting request to set the exclusive control right to exclude the intervention by other transmitting apparatus and/or the controller.

The exclusive control right setting response unit receives, from the receiving apparatus to which the exclusive control right setting request is transmitted, the exclusive control right setting response indicating that the exclusive control right setting request is accepted and the exclusive control right is set (ACCEPTED) or that the exclusive control right setting request is rejected and the exclusive control right is not set (REJECTED).

The exclusive control right release request unit transmits the exclusive control right release request to the receiving apparatus which transmitted the exclusive control right setting request, when the signal transmission by the signal transmitting unit 302 ends, i.e., when the signal reproduction by the receiving apparatus ends.

The exclusive control right release response unit receives, from the receiving apparatus which transmits the exclusive control right release request, the exclusive control right release response indicating that the exclusive control right release request is accepted and the exclusive control right is released (ACCEPTED) or that the exclusive control right release request is rejected and the exclusive control right is not released (REJECTED).

In this embodiment, in order to set the exclusive control right to exclusively control the connection operation, it is assumed to use the RESERVE command which is standardized by 1394TA (Trade Association) and defined in “AV/C Digital Interface Command Set General Specification Version 4.2” or a command set to establish the connection of IEC61883-1 defined in “AV/C Connection and Compatibility Management Specification 1.0” on the receiving apparatus side by using the AV/C command. However, since these commands exclusively control, not only the connection operation, but all the operations, the volume operation necessary for the user cannot be performed during the exclusive control, for example. Therefore, the present invention is not limited to the above, and a new command to exclusively control only the connection operation may be used.

The connection control monitoring unit 308 controls and monitors the establishment and the cutting of the connection necessary for the signal transmitting unit 302 to transmit the signals to the receiving apparatus set by the receiving apparatus setting unit 304, and includes the connection state confirming unit, the connection establishment request unit, the connection establishment response unit, the connection cut request unit and the connection cut response unit. The establishment of the connection is realized by associating the logical output plug (oPCR[i]) of the transmitting apparatus with the logical input plug (iPCR[i]) of the transmitting apparatus by the channel information, by using the IEEE1394 transaction.

The connection state confirming unit transmits the connection state confirmation request to confirm whether or not the receiving apparatus which performed the exclusive control right setting request by the exclusive control managing unit 307 has already established the connection. Also, the connection state confirming unit receives, from the receiving apparatus which transmitted the connection state confirmation request, the connection state confirmation response indicating the connection state at the time of receiving the request. When the signal transmitted by the signal transmitting unit 302 is the interruption signal, the connection state confirmation response received by the connection state confirming unit is the information relating to the transmitting apparatus and the receiving apparatus of the connection existing before the interruption signal reproduction. For example, when the receiving apparatus is the amplifier 17 and it has already established the connection with the DTV 14, the connection state confirming unit receives the connection state confirmation response indicating that the connection is being established with the DVT 14 (e.g., “DTV-AMP”). On the contrary, when the receiving apparatus has not established the connection, the connection state confirming unit receives the connection state confirmation response indicating that the connection is not being established (e.g., “NO CONNECTION”).

The connection establishment request unit transmits, to the receiving apparatus set by the receiving apparatus setting unit 304, i.e., the receiving apparatus which performed the exclusive control right setting request by the exclusive control managing unit 308, the connection establishment request to establish the connection with itself, i.e., with the transmitting apparatus. In this way, the connection establishment request unit establishes the connection to transmit the interruption signal.

The connection establishment response unit receives, from the receiving apparatus which transmitted the connection establishment request, the connection establishment response indicating that the connection establishment request is accepted and the connection is established (ACCEPTED) or that the connection establishment request is rejected and the connection is not established (REJECTED).

The connection cut request unit transmits, to the receiving apparatus which performed the exclusive control right setting request by the exclusive control managing unit 307, the connection cut request to cut the connection.

The connection cut response unit receives, from the receiving apparatus which transmitted the connection cut request by the connection cut request unit, the connection cut response indicating that the connection cut request is accepted and the connection is cut (ACCEPTED) or that the connection cut request is rejected and the connection is not cut (REJECTED).

The command transmitting/receiving unit 309 performs the transmission and reception of the commands for the management of the exclusive control by the exclusive control managing unit 307 and/or for the control of the connection by the connection control monitoring unit 308. For example, the command transmitting/receiving unit 309 transmits, to the receiving apparatus, the command corresponding to the exclusive control right setting request, the exclusive control right release request, the connection state confirmation request, the connection establishment request and the connection cut request. Also, the command transmitting/receiving unit 309 receives, from the receiving apparatus, the commands corresponding to the exclusive control right setting response, the exclusive control right release response, the connection state confirmation response, the connection establishment response and the connection cut response.

The plug register managing unit 310 manages the logical output plug of the transmitting apparatus. For example, in this embodiment, as shown in FIG. 9, the plug register managing unit 310 manages the output plug (oPCR[0]) of the plug ID[0] and the output plug (oPCR[1]) of the plug ID[1]. The output plug of the plug ID[0] outputs the signal whose signal type is the AV signal, and the output plug of the plug ID[1] outputs the signal whose signal type is the guide information and/or the video information.

It is noted that the above-mentioned units are realized by the CPU of the transmitting apparatus which executes the program prepared in advance.

(ii) Recovering Process by Transmitting Apparatus

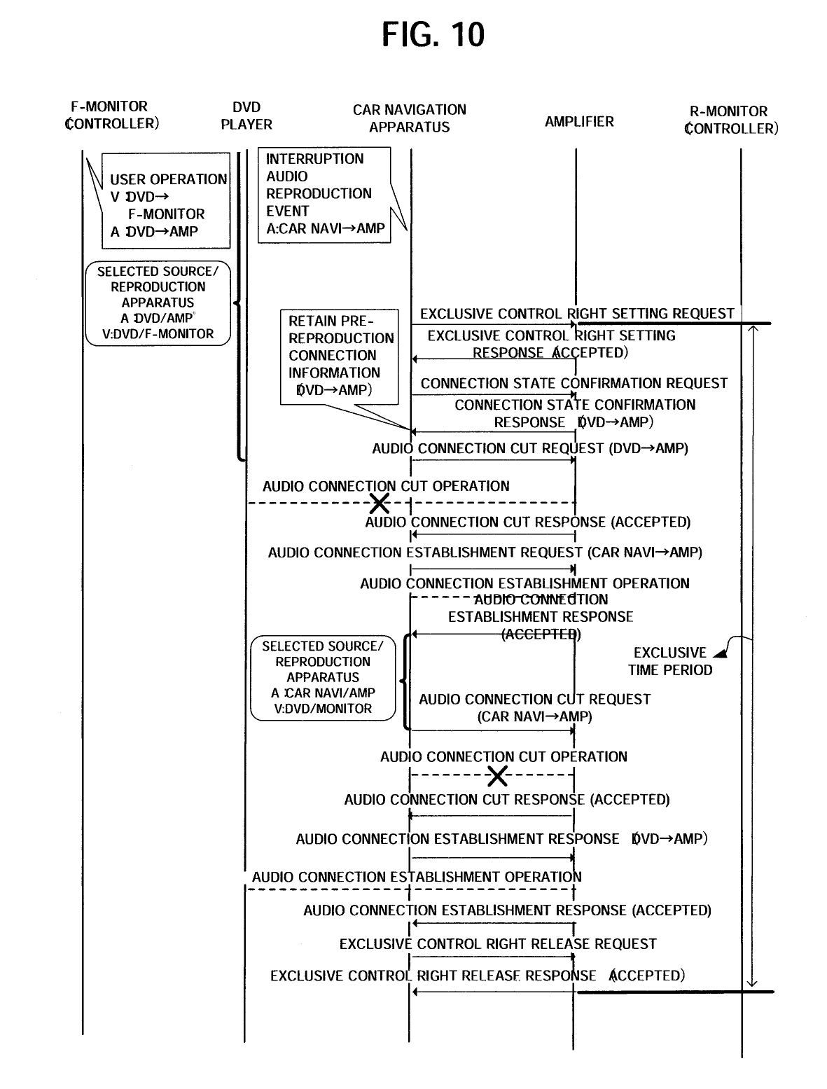

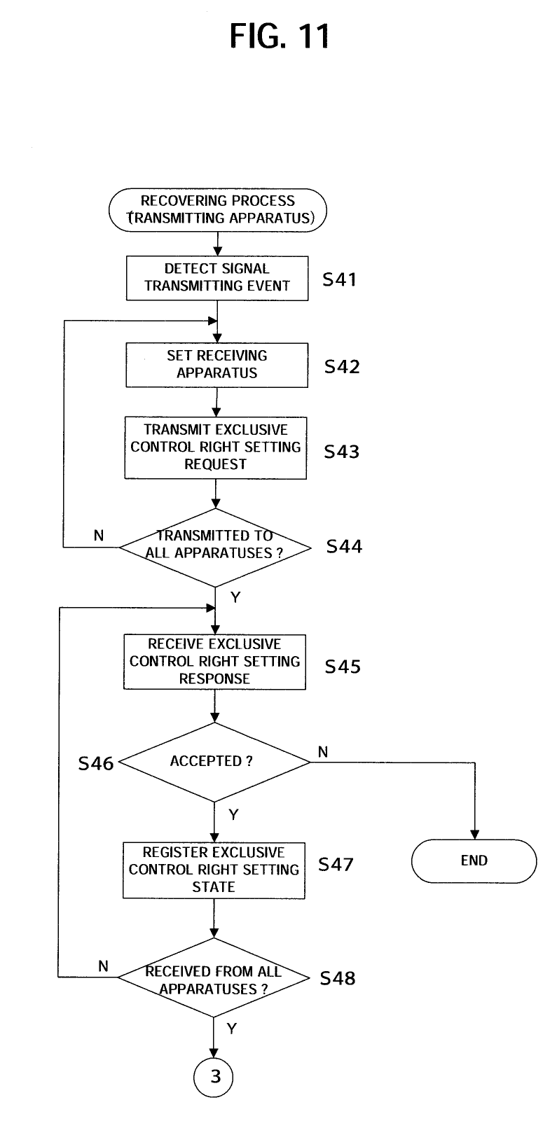

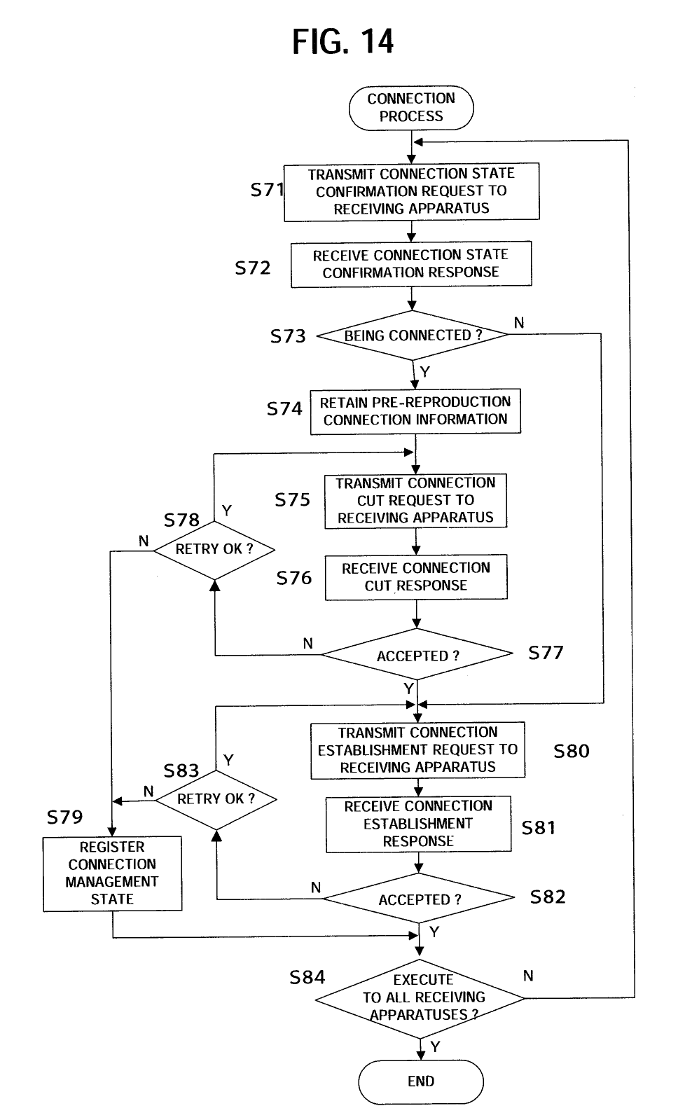

Next, the recovering processing by the transmitting apparatus of this embodiment will be described with reference to FIGS. 10 to 14. FIG. 10 is a sequence diagram of the recovering process in the car AV system 1. FIGS. 11 to 13 are the flowcharts of the recovering process by the transmitting apparatus. FIG. 14 is a flowchart of the connection process executed in the recovering process.

The recovering process is to retain the pre-reproduction connection information relating to the connection existing before the interruption signal reproduction, and re-establish the original connection after the interruption signal reproduction based on the pre-reproduction connection information. In this embodiment, the interruption signal transmitting apparatus is the car navigation apparatus 13, and the interruption signal receiving apparatus is the amplifier 17. The interruption signal receiving apparatus receives the audio signal of the guide voice. It is assumed that the amplifier 17 serving as the interruption signal receiving apparatus has established the audio connection with the DVD player 12 before the interruption signal reproduction. By this, the amplifier 17 interrupts the audio signal received from the DVD player 12, and receives the audio signal from the car navigation apparatus 13 to reproduce the guide voice by interruption. When the reproduction of the guide voice ends, the car navigation apparatus 13 requests the amplifier 17 to re-establish the audio connection with the DVD player 12. When the amplifier 17 re-establishes the audio connection with the DVD player 12, it receives the audio signal from the DVD player 12 to reproduce the corresponding audio.

As shown in FIGS. 10 and 11, the signal transmitting event detecting unit 301 of the transmitting apparatus control unit 300 in the car navigation apparatus 13 serving as the interruption signal transmitting apparatus detects that the event to transmit the audio signal of the guide voice as the interruption signal occurs (step S41). Then, the receiving apparatus setting unit 304 obtains the information relating to the receiving apparatus recognized by the apparatus recognizing unit 303, and sets the receiving apparatus to which the audio signal serving as the interruption signal is transmitted (step S42). In this embodiment, the receiving apparatus setting unit 304 sets the amplifier 17 as the receiver of the audio signal being the interruption signal. When the interruption signal is the audio signal and the video signal, the receiving apparatus setting unit 304 also sets the receiving apparatus to which the video signal is transmitted.

Namely, the receiving apparatus setting unit 304 sets a plurality of receiving apparatuses as the receiver of the interruption signal.

Then, the exclusive control right setting request unit of the exclusive control managing unit 307 transmits the exclusive control right setting request to the receiving apparatus set by the receiving apparatus setting unit 304 (step S43). Namely, the car navigation apparatus 13 sets the exclusive control to the amplifier 17 by transmitting the exclusive control right setting request to the amplifier 17 to which the interruption signal is transmitted. Subsequently, the exclusive control right setting request unit determines whether or not the exclusive control right setting request is transmitted to all of the receiving apparatuses set by the receiving apparatus setting unit 304 (step S44). When the exclusive control right setting request is not transmitted to all of the receiving apparatuses (step S44; No), the exclusive control right setting request unit repeatedly executes the process of steps S42 and S43. On the contrary, when the exclusive control right setting request is transmitted to all of the receiving apparatuses (step S44; Yes), the exclusive control right setting response unit receives, from the receiving apparatus, the exclusive control right setting response indicating that the exclusive control right setting request is accepted or rejected (step S45).

The exclusive control managing unit 307 determines whether or not the exclusive control right setting request is accepted, based on the exclusive control right setting response received from the receiving apparatus (step S46). When the exclusive control right setting request is rejected (step S46; No), the transmitting apparatus control unit 300 ends the recovering process. When the interruption signal is the associated video signal and audio signal, if the exclusive control right setting request of the video signal receiving apparatus is rejected but the exclusive control right setting request of the audio signal receiving apparatus is accepted, the recovering process may go to step S47 to continue, without ending it, in consideration of the importance of the interruption signal.

On the contrary, when the exclusive control right setting request is accepted (step S46; Yes), the exclusive control managing unit 307 registers the exclusive control right setting state (step S47). Then, the exclusive control right setting response unit determines whether or not to receive the exclusive control right setting response from all of the receiving apparatuses (step S48). When the exclusive control managing unit 307 does not receive the exclusive control right setting response from all of the receiving apparatuses (step S48; No), it repeatedly executes the process of steps S45 to S48. However, repeating the process in case that the exclusive control right setting request is rejected may be limited by a predetermined retry times, and the recovering process may end if the retries are continuously rejected over the predetermined retry times. Also in this case, if the exclusive control right setting request of apart of the receiving apparatuses (e.g., the audio receiving apparatus) is accepted, the process may go to step S49 to execute the connection process, without ending the recovering process, in consideration of the importance of the interruption signal.

On the contrary, when receiving the exclusive control right setting response from all of the receiving apparatuses (step S48; Yes), the transmitting apparatus control unit 300 executes the connection process (step S49).

Specifically, by the process so far, as shown in FIG. 10, when the amplifier 17 receives the exclusive control right setting request from the car navigation apparatus 13, it accepts the exclusive control right setting request to set the exclusive control right to the amplifier 17, and transmits the exclusive control right setting response (ACCEPTED) to the car navigation apparatus 13. When receiving the exclusive control right setting response (ACCEPTED), the transmitting apparatus control unit 300 of the car navigation apparatus 13 executes the connection process.

In the connection process, as shown in FIG. 14, the connection state confirming unit of the transmitting apparatus control unit 300 transmits the connection state confirmation request to the receiving apparatus set by the receiving apparatus setting unit 304 (step S71). The connection state confirming unit receives the connection state confirmation response indicating the connection state from the receiving apparatus (step S72). Then, the connection state confirming unit determines whether or not the receiving apparatus has already established the connection, i.e., connected, with other apparatus, based on the connection state confirmation response received from the receiving apparatus (step S73). The receiving apparatus is not connected (step S73; No), the transmitting apparatus control unit 300 goes to step S78.

On the contrary, when the receiving apparatus is connected (step S73; Yes), the pre-reproduction connection information retaining unit 305 retains the information relating to the transmitting apparatus and the receiving apparatus of the connection existing before the interruption signal reproduction as the pre-reproduction connection information, based on the connection state confirmation response received from the receiving apparatus (step S74). When the pre-reproduction connection information is retained, the connection cut request unit transmits, to the receiving apparatus, the connection cut request to cut the connection already established (step S75). When the receiving apparatus receives the connection cut request, it cuts the connection being established at that time. Then, the receiving apparatus transmits the connection cut response indicating that the connection cut request is accepted and the connection is cut or that the connection cut request is rejected and the connection is not cut.

The connection cut response unit receives the connection cut response from the receiving unit (step S76). Subsequently, the connection cut response unit determines whether or not the connection cut request is accepted, based on the connection cut response received from the receiving apparatus (step S77). When the connection cut request is rejected (step S77; No), the connection control monitoring unit 308 determines whether or not the retry of the connection cut is possible, based on the factor of the rejection, i.e., the failure factor of the connection cut (step S78). For example, if the failure factor is the temporary rejection of the control command and the process can be continued by the retry, the connection control monitoring unit 308 determines that the retry of the connection cut is possible, and reties the connection cut after a predetermined waiting time passes, with managing the number of times of the retry. Therefore, if the retry is possible (step S78), the connection control monitoring unit 308 repeatedly executes the process of steps S75 to S77. On the contrary, if the retry is not possible (step S78; No), the connection control monitoring unit 308 retains “connection cut failure” as the management state of the connection with the receiving apparatus at that time, and goes to step S84 (step S79). By this, the process after step S80 is executed only for the receiving apparatus which successfully cut the connection. Therefore, when the connection process with a part of the receiving apparatuses (e.g., the audio receiving apparatus) is going without any problem, it is possible to proceed to the next process even if there occurs a problem in the connection process with other receiving apparatus (e.g., the video receiving apparatus).

On the contrary, when the connection cut request is accepted (step S77; Yes), the connection establishment request unit transmits, to the receiving apparatus, the connection establishment request to establish the connection with itself, i.e., the transmitting apparatus (step S80). When the receiving apparatus receives the connection establishment request, it establishes the connection between the input plug of its own and the output plug of the transmitting apparatus. Then, the receiving apparatus transmits the connection establishment response indicating that the connection establishment request is accepted and the connection is established or that the connection establishment request is rejected and the connection is not established.

The connection establishment response unit receives the connection establishment response (step S81). Subsequently, the connection establishment response unit determines whether or not the connection establishment request is accepted, based on the connection establishment response received from the receiving apparatus (step S82). When the connection establishment request is rejected (step S82; No), the connection control monitoring unit 308 determines whether or not the retry of the connection establishment is possible based on the factor of the rejection, i.e., the failure factor of the connection establishment (step S83). When continuing the process by the retry is possible, the connection control monitoring unit 308 determines that the retry is possible, and retries the connection establishment after the predetermined waiting time passes, with managing the number of retry times. Therefore, when the retry is possible (step S83; Yes), the connection control monitoring unit 308 repeatedly executes the process of steps S80 to S82. On the contrary, when the retry is not possible (step S83; No), the connection control monitoring unit 308 retains “connection establishment failure” as the management state of the receiving apparatus at that time, and goes to step S84 (step S79).

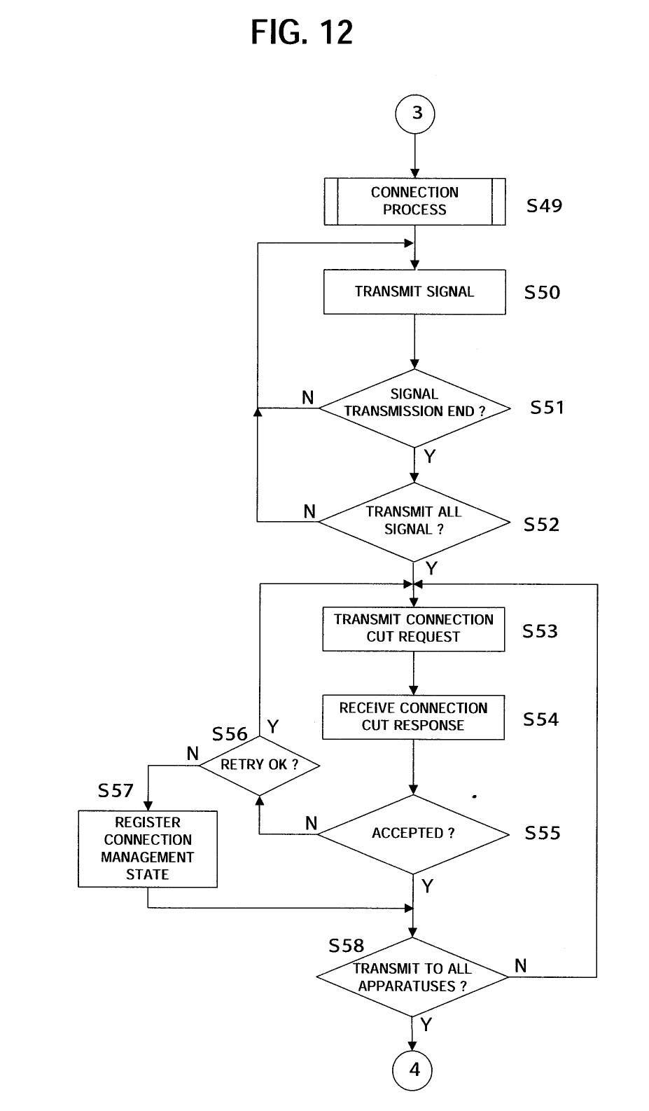

On the contrary, when the connection establishment request is accepted (step S82; Yes), the control unit 300 determines whether or not the connection process is executed for all of the receiving apparatuses to which the exclusive control right is successfully set (step S84). When the connection process is not executed for all of the receiving apparatuses (step S84; No), the control unit 300 repeatedly executes the process of steps S71 to 84, and executes the connection process for the receiving apparatus for which the connection process is not executed yet. On the contrary, when the connection process is executed for all of the receiving apparatuses (step S84; Yes), the transmitting apparatus control unit 300 ends the connection process, and goes to step S50 shown in FIG. 12. The process after step S50 is executed only for the receiving apparatus which successfully executed the connection process, i.e., the connection cut and the connection establishment are succeeded.

Specifically, in the connection process, as shown in FIG. 10, the connection state confirming unit of the car navigation apparatus 13 transmits the connection state confirmation request to the amplifier 17 serving as the interruption signal receiving apparatus. In this case, the amplifier 17 transmits the connection state confirmation response (DVD-AMP) indicating that the connection has already established with the DVD player 12. Namely, the connection state confirming unit receives, from the amplifier 17, the information relating to the transmitting apparatus and the receiving apparatus of the connection existing before the interruption signal reproduction. The pre-reproduction connection information retaining unit 305 retains the information relating to the transmitting apparatus and the receiving apparatus of the connection existing before the interruption signal reproduction, as the pre-reproduction connection information, based on the connection state confirmation response received from the amplifier 17. The pre-reproduction connection information includes the information indicating that the connection has already established between the DVD player 12 serving as the transmitting apparatus and the amplifier 17 serving as the receiving apparatus.

When the pre-reproduction connection information is retained, the connection cut request unit transmits, to the amplifier 17, the connection cut request (the audio connection cut request) which is a request to cut the connection with the DVD player 12. When receiving the connection cut request, the amplifier 17 cuts the connection with the DVD player 12, and transmits the connection cut response (ACCEPTED) to the car navigation apparatus 13. The connection establishment request unit which received the connection cut response (the audio connection cut response) transmits, to the amplifier 17, the connection establishment request (the audio connection establishment request) to establish the connection with itself, i.e., the car navigation apparatus 13. The amplifier 17 which received the connection establishment request executes the audio connection establishment operation to establish the connection between the input plug of its own and the output plug of the car navigation apparatus 13. Then, the amplifier 17 transmits the connection establishment response indicating that the connection establishment request is accepted and the connection is established (ACCEPTED). Namely, the connection establishment response unit receives the connection establishment response (the audio connection establishment response) from the amplifier 17.

When the connection process ends, as shown in FIG. 12, the signal transmitting unit 302 transmits the signal to the receiving apparatus via the connection established by the connection control monitoring unit 308 (step S50). Then, the signal transmitting unit 308 determines whether or not the signal transmission to the receiving apparatus ends (step S51). When the signal transmission to the receiving apparatus does not end (step S51; No), the signal transmitting unit 302 repeatedly execute the process of steps S50 and S51 until the signal transmission to the receiving apparatus ends. The receiving apparatus reproduces the signal to output the video or the audio by the display or the speaker.

When the signal transmission to the receiving apparatus ends (step S51; Yes), the signal transmitting unit 302 determines whether or not all signals are transmitted (step S52). When all signal are not transmitted (step S52; No), the signal transmitting unit 302 repeatedly executes the process of steps S50 to S52. On the contrary, when all signals are transmitted (step S52; Yes), the connection cut request unit transmits the connection cut request to cut the connection, to the receiving apparatus to which the connection establishment request unit transmits the connection establishment request and the connection establishment succeeded (step S53). When receiving the connection cut request, the receiving apparatus cuts the connection with the transmitting apparatus. Then, the receiving apparatus transmits the connection cut response indicating that the connection cut request is accepted and the connection is cut or that the connection cut request is rejected and the connection is not cut.

The connection cut response unit receives the connection cut response from the receiving apparatus (step S54). Subsequently, the connection cut response unit determines whether or not the connection cut request is accepted, based on the connection cut response received from the receiving apparatus (step S55). When the connection cut request is rejected (step S55; No), the connection control monitoring unit 308 determines whether or not the retry of the connection cut is possible, based on the factor of rejection, i.e., the failure factor of the connection cut (step S56). When the process can be continued by the retry, the connection control monitoring unit 308 determines that the retry is possible, and executes the retry after the predetermined waiting time passes, with managing the number of retry times. Therefore, when the retry is possible (step S56; Yes), the connection control monitoring unit 308 repeatedly executes the process of steps S53 to S55. On the contrary, when the retry is not possible (step S56; No), the connection control monitoring unit 308 retains “connection cut failure” as the management state of the receiving apparatus and the connection at that time, and goes to step S58 (step S57).

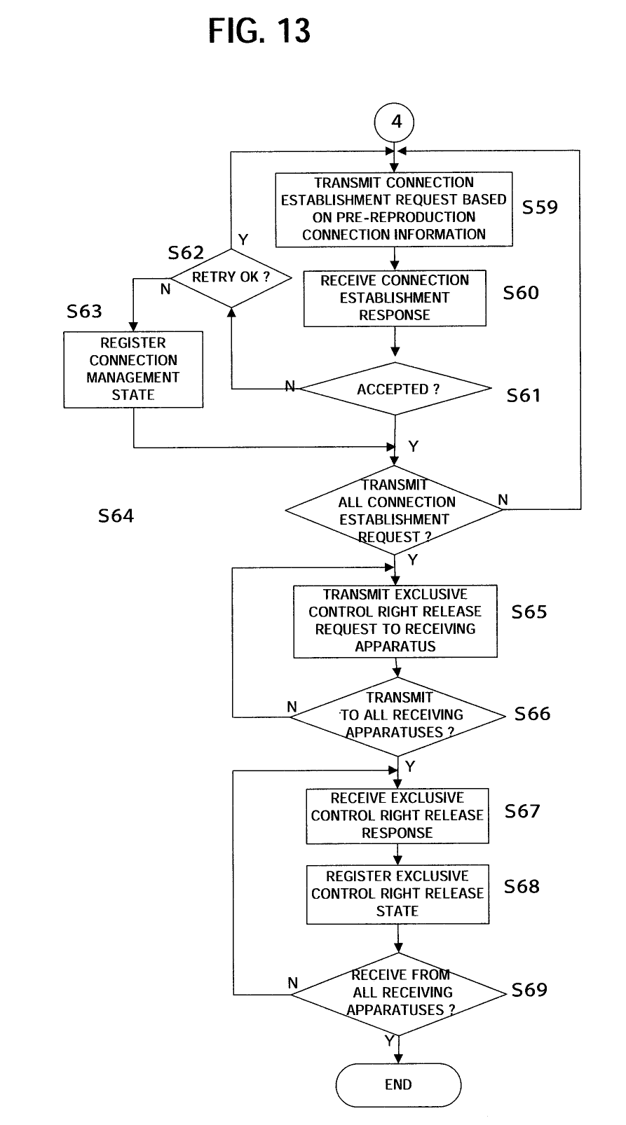

When the connection establishment request is accepted (step S55; Yes), the control unit 300 determines whether or not the connection cut request is transmitted to all of the receiving apparatuses which successfully set the exclusive control right (step S58). When the connection cut request is not transmitted to all of the receiving apparatuses (step S58; No), the control unit 300 transmits the connection cut request to the remaining receiving apparatus to which the connection cut request is not transmitted yet. On the contrary, when the connection cut request is transmitted to all of the receiving apparatuses (step S58; Yes), the control unit 300 goes to step S59 shown in FIG. 13.

The connection establishment request unit transmits, to the receiving apparatuses, the connection establishment request to re-establish the connection existed before the interruption signal reproduction, based on the pre-reproduction connection information retained by the pre-reproduction connection information retaining unit 305 (Step S59). When receiving the connection establishment request, the receiving apparatus establishes the connection. Then, the receiving apparatus transmits the connection establishment response indicating that the connection establishment request is accepted and the connection is established or that the connection establishment request is rejected and the connection is not established.

The connection establishment response unit receives the connection establishment response from the receiving apparatus (step S60). Subsequently, the connection establishment response unit determines whether or not the connection establishment request is accepted, based on the connection establishment response received from the receiving apparatus (step S61). When the connection establishment request is rejected (step S61; No), the connection control monitoring unit 308 determines whether or not the retry of the connection establishment is possible, based on the factor of the rejection, i.e., the failure factor of the connection establishment (step S62). When the process can be continued by the retry, the connection control monitoring unit 308 determines that the retry is possible, and executes the retry after the predetermined waiting time passes, with managing the number of the retry times. Therefore, when the retry is possible (step S62; Yes), the connection control monitoring unit 308 repeatedly executes the process of steps S59 to S61. On the contrary, when the retry is not possible (step S62; No), the connection control monitoring unit 308 retains “connection establishment failure” as the management state of the receiving apparatus and the connection, and goes to step S64 (step S63).

The connection control monitoring unit 308 determines whether or not all of the connection establishment requests to re-establish the connection existed before the interruption signal reproduction are transmitted (step S64). When all of the connection establishment requests are not transmitted (step S64; No), the connection control monitoring unit 308 repeatedly executes the process of steps S59 to S64, and transmits the connection establishment request to the remaining receiving apparatus to which the connection establishment request is not transmitted yet. On the contrary, when all of the connection establishment requests are transmitted (step S64; Yes), the exclusive control right release request unit transmits the exclusive control right release request to release the exclusive control right to the receiving apparatus which transmitted the exclusive control right setting request (step S65). The exclusive control right release request unit determines whether or not the exclusive control right release request is transmitted to all of the receiving apparatus whose exclusive control right is not released yet (step S66). When the exclusive control right release request is not transmitted to all of the receiving apparatuses (step S66), the exclusive control right release request unit repeatedly executes the process of steps S65 to S66. On the contrary, when the exclusive control right release request is transmitted to all of the receiving apparatuses (step S66; Yes), the exclusive control right release response unit receives the exclusive control right release response indicating that the exclusive control right release request is accepted or the exclusive control right release request is rejected (step S67). The exclusive control right release response unit registers the exclusive control right releasing state based on the exclusive control right release response received from the receiving apparatus (step S68). Then, the exclusive control right release response unit determines whether or not it receives the exclusive control right release response from all of the receiving apparatuses to which the exclusive control right is set (step S69). When the exclusive control right release response unit does not receive the exclusive control right release response from all of the receiving apparatuses (step S69; No), the exclusive control right release response unit repeatedly executes the process of steps S67 to S69. On the contrary, when the exclusive control right release response unit receives the exclusive control right release response from all of the receiving apparatuses (step S69; Yes), the transmitting apparatus control unit 300 ends the recovering process.

Specifically, by the process so far, as shown in FIG. 10, when the interruption signal transmission to the amplifier 17 and the interruption signal reproduction end, the connection cut request unit transmits, to the amplifier 17, the connection cut request (the audio connection cut request) to cut the audio connection. When receiving the audio connection cut request, the amplifier 17 performs the cut operation to cut the audio connection with the car navigation apparatus 13. Then, the amplifier 17 transmits, to the car navigation apparatus 13, the connection cut response (ACCEPTED) indicating that the audio connection cut request is accepted and the audio connection is cut. Namely, the connection cut response unit of the car navigation apparatus 13 receives, from the amplifier 17, the connection cut response (the audio connection cut response) indicating that the connection with itself, i.e., the car navigation apparatus 13 is cut.

Then, the connection establishment request unit transmits, to the amplifier 17, the connection establishment request (the audio connection establishment request) to re-establish the audio connection with the DVD player 12, based on the pre-reproduction connection information retained by the pre-reproduction connection information retaining unit 305. The amplifier 17 re-establishes the audio connection with the DVD player 12 to recover it, based on the connection establishment request. Then, the amplifier 17 accepts the connection establishment request, and transmits the connection establishment response (ACCEPTED) indicating that the audio connection with the DVD player 12 is re-established to the car navigation apparatus 13. Namely, the connection establishment response unit receives the connection establishment response (the audio connection establishment response) from the amplifier 17.

When receiving the connection establishment response (ACCEPTED), the exclusive control right release request unit transmits, to the amplifier 17, the exclusive control right release request to release the exclusive control right. When the exclusive control right is released, the exclusive control right release response unit receives, from the amplifier 17, the exclusive control right release response (ACCEPTED) indicating that the exclusive control right release request is accepted and the exclusive control right is released (ACCEPTED). By this, the transmitting apparatus control unit 300 ends the recovering process.

As described above, in this embodiment, the transmitting apparatus which transmits the interruption signal performs the recovery of the connection existed before the interruption signal reproduction. Since the transmitting apparatus manages the transmission of the interruption signal and the start and the end of the reproduction, the transmitting apparatus can easily recognize the reproduction state of the interruption signal. Therefore, the transmitting apparatus can transmit the connection establishment request and the connection cut request to the receiving apparatus at appropriate timings, based on the reproduction state.

In addition, the transmitting apparatus controls such that the time until the original connection is re-established is the exclusive time period. By this, it can be prevented that the original connection cannot be recovered by the intervention by other apparatus.

### 3rd Embodiment

In the third embodiment, when the connection is switched for the interruption signal reproduction, the controller which controls the original connection retains the pre-reproduction connection information relating to the connection existing before the interruption signal reproduction, and executes the process to recover the original connection after the interruption signal reproduction ends based on the pre-reproduction connection information.

(i) Control Apparatus Control Unit

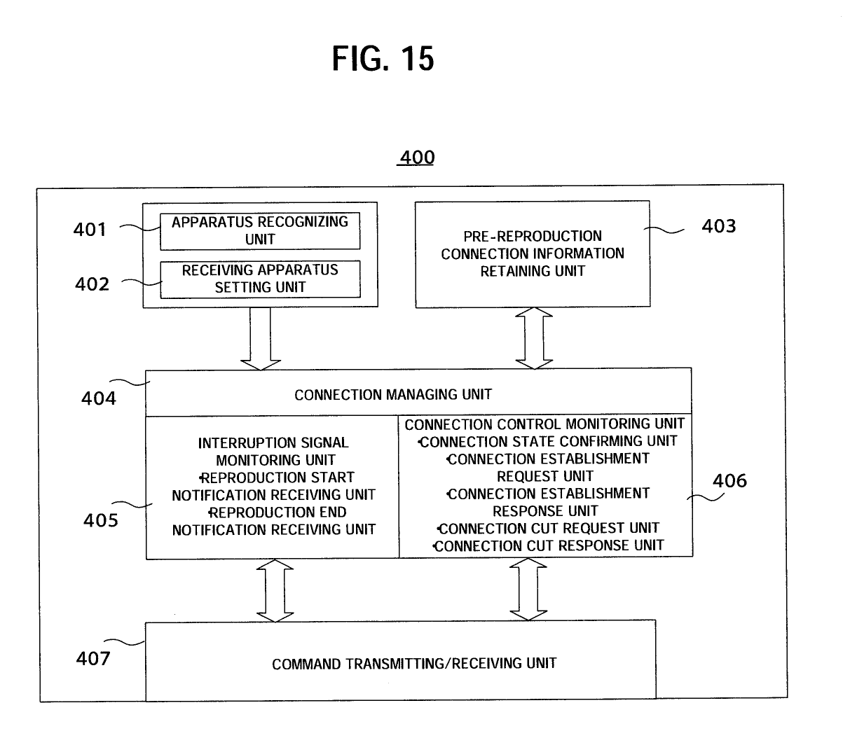

First, the control apparatus control unit 400 configured by the constitutional elements of the controller will be described with reference to FIG. 15. FIG. 15 is a block diagram of the control apparatus control unit 400.

The control apparatus control unit 400 retains the pre-reproduction connection information relating to the connection existing before the interruption signal reproduction, and re-establishes the original connection after the interruption signal reproduction, based on the pre-reproduction connection information.

As shown in FIG. 15, the control apparatus control unit 400 includes an apparatus recognizing unit 401, a receiving apparatus setting unit 402, a pre-reproduction connection information retaining unit 403, a connection managing unit 404, an interruption signal monitoring unit 405, a connection control monitoring unit 406 and a command transmitting/receiving unit 407.

The apparatus recognizing unit 401 recognizes the apparatus to which the controller is connected on the network.

The receiving apparatus setting unit 402 obtains the information relating to the receiving apparatus recognized by the apparatus recognizing unit 401, and sets the receiving apparatus to which the video signal and the audio signal are transmitted.

The pre-reproduction connection information retaining unit 403 retains the information relating to the receiving apparatus and the transmitting apparatus of the connection existing before the interruption signal reproduction, as the pre-reproduction information, when it receives the interruption signal reproduction start notification from the reproduction start notification receiving unit described later. The pre-reproduction connection information retaining unit 403 functions as the pre-reproduction connection information retaining means in the control apparatus of the present invention.

The connection managing unit 404 manages the exclusive control of the receiving apparatus reproducing the signal and the establishment and the cutting of the connection to transmit the signal. The connection managing unit 404 includes the interruption signal monitoring unit 405 and the connection control monitoring unit 406.

The interruption signal monitoring unit 405 monitors the notification indicating the switching of the connection for reproducing the interruption signal, and includes a reproduction start notification receiving unit and a reproduction end notification receiving unit.

The reproduction start notification receiving unit receives, from the transmitting apparatus which transmits the interruption signal, the interruption signal reproduction start notification indicating that the connection between the transmitting apparatus and the receiving apparatus is switched to the connection for transmitting the interruption signal, for the reproduction of the interruption signal. The reproduction start notification receiving unit transmits the interruption signal reproduction start notification to the pre-reproduction connection information retaining unit 403 described later, when the connection established by the control of the controller is switched to other connection for the interruption signal transmission. The reproduction start notification receiving unit functions as the reproduction start notification receiving means in the control apparatus of the present invention.

The reproduction end notification receiving unit receives, from the transmitting apparatus which transmits the interruption signal, the interruption signal reproduction end notification indicating that the transmission (reproduction) of the interruption signal ends. When the interruption signal reproduction start notification is transmitted to the pre-reproduction connection information retaining unit 403 by the reproduction start notification receiving unit, the reproduction end notification receiving unit transmits the received interruption signal reproduction end notification to the connection control monitoring unit 406. The reproduction end notification receiving unit functions as the reproduction end notification receiving means in the control apparatus of the present invention.

The connection control monitoring unit 406 controls and monitors the establishment and the cutting of the connection, and includes a connection state confirming unit, a connection establishment request unit, a connection establishment response unit, a connection cut request unit and a connection cut response unit. The establishment of the connection is realized by associating the logical output plug (oPCR[i]) of the transmitting apparatus with the logical input plug (iPCR[i]) of the receiving apparatus by the channel information, by using the IEEE1934 transaction.

The connection state confirming unit transmits, to the receiving apparatus, the connection state confirmation request to confirm whether or not the receiving apparatus has established the connection. Also, the connection state confirming unit receives, from the receiving apparatus which transmitted the connection state confirmation request, the connection state confirmation response indicating the connection state at the time when it receives the request.

The connection establishment request unit transmits, to the receiving apparatus, the connection establishment request to establish the connection with the designated transmitting apparatus.

The connection establishment response unit receives, from the receiving apparatus which transmitted the connection establishment request, the connection establishment response indicating that the connection establishment request is accepted and the connection is established (ACCEPTED) or that the connection establishment request is rejected and the connection is not established (REJECTED).

The connection cut request unit transmits the connection cut request to cut the connection.

The connection cut request response unit receives, from the receiving apparatus which transmitted the connection cut request by the connection cut request unit, the connection cut response indicating that the connection cut request is accepted and the connection is cut (ACCEPTED) or that the connection cut request is rejected and the connection is not cut (REJECTED).

The command transmitting/receiving unit 407 transmits and receives the command to control the connection by the connection control monitoring unit 406. For example, the command transmitting/receiving unit 407 receives, from the transmitting apparatus which transmits the interruption signal, the command corresponding to the interruption signal reproduction start notification and the interruption signal reproduction end notification. Also, the command transmitting/receiving unit 407 receives, from the receiving apparatus, the command corresponding to the connection state confirmation response, the connection establishment response and the connection cut response. Further, the command transmitting/receiving unit 407 transmits, to the receiving apparatus, the command corresponding to the connection state confirmation request, the connection establishment request and the connection cut request.

Each of the above-mentioned units is realized by the CPU of the controller which executes the program prepared in advance.

(ii) Recovering Process by Controller

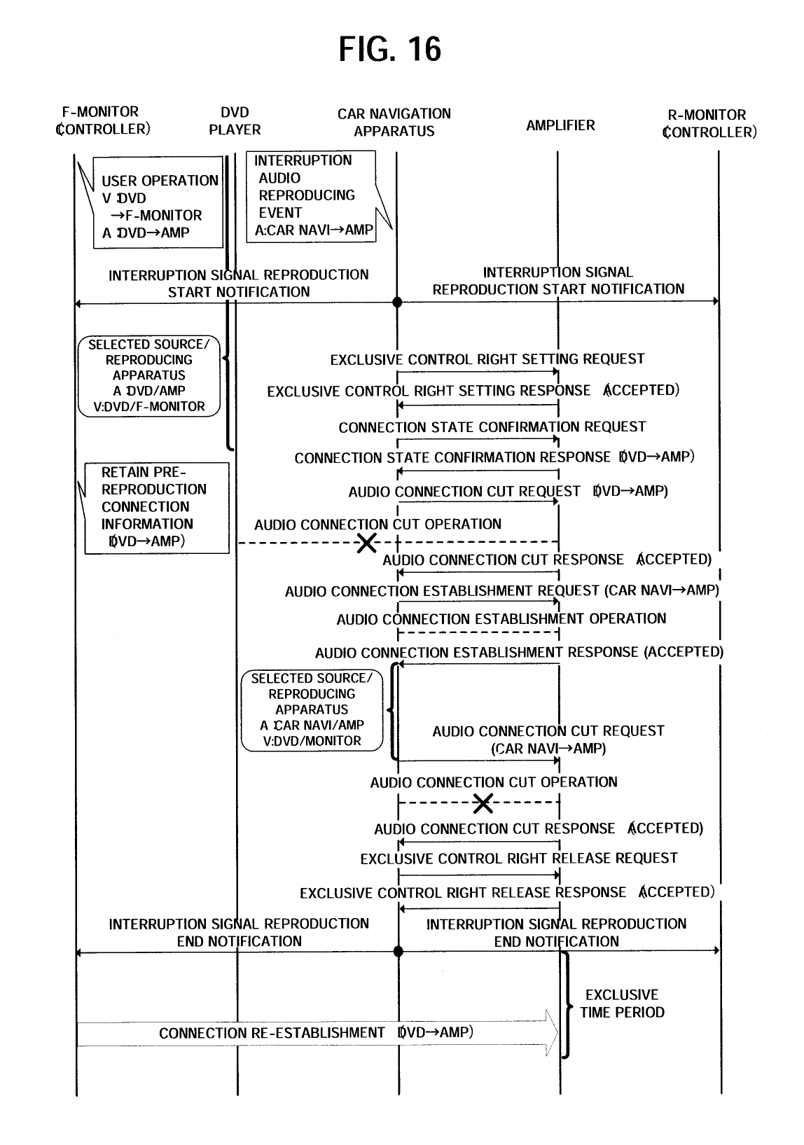

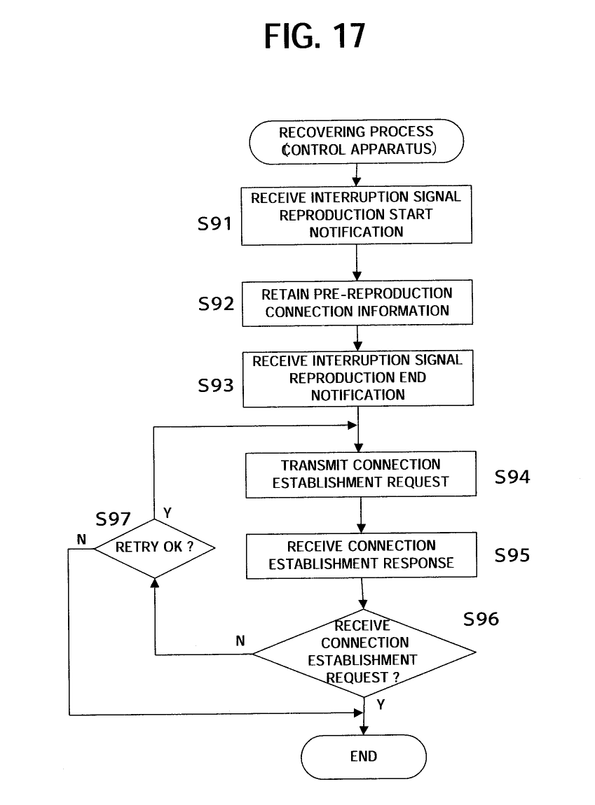

Next, the recovering process by the controller of this embodiment will be described with reference to FIGS. 16 and 17. FIG. 16 is a sequence diagram of the recovering process in the car AV system 1. FIG. 17 is a flowchart of the recovering process by the controller.

The recovering process is to retain the pre-reproduction connection information relating to the connection existing before the interruption signal reproduction, and to re-establish the original connection after the interruption signal reproduction ends, based on the pre-reproduction connection information. In this embodiment, the interruption signal transmitting apparatus is the car navigation apparatus 13, and the interruption signal receiving apparatus is the amplifier 17. The interruption signal receiving apparatus receives the audio signal of the guide voice. It is assumed that the amplifier 17 serving as the interruption signal receiving apparatus has established the audio connection with the DVD player 12 by the F-monitor 11 serving as the controller, before the interruption signal reproduction. By this, the amplifier 17 interrupts the audio signal received from the DVD player 12, and receives the audio signal from the car navigation apparatus 13 to reproduce the guide voice by interruption. When the reproduction of the guide voice ends, the F-monitor 11 serving as the controller re-establishes the audio connection between the amplifier 17 and the DVD player 12. Therefore, the amplifier 17 receives the audio signal from the DVD player 12 to reproduce the corresponding audio.

As shown in FIG. 16, when the interruption audio reproduction event occurs, the car navigation apparatus 13 transmits the interruption signal reproduction start notification to all of the apparatus functioning as the controller. In the control apparatus control unit 400 in the controller, i.e., the F-monitor 11, as shown in FIG. 17, the reproduction start notification receiving unit receives the interruption signal reproduction start notification from the transmitting apparatus which transmits the interruption signal, i.e., the car navigation apparatus 13 (step S91). The reproduction start notification receiving unit transmits the received interruption signal reproduction start notification to the pre-reproduction connection information retaining unit 403. When receiving the interruption signal reproduction start notification, the pre-reproduction connection information retaining unit 403 retains the information relating to the transmitting apparatus and the receiving apparatus of the connection existing before the interruption signal reproduction as the pre-reproduction connection information (step S92). Specifically, the pre-reproduction connection information retaining unit 403 retains the pre-reproduction connection information indicating that the amplifier 17 serving as the receiving apparatus and the DVD player 12 serving as the transmitting apparatus have established the audio connection.

As shown in FIG. 16, the car navigation apparatus 13 which transmitted the interruption signal reproduction start notification to the controller sets the exclusive control rights, and establishes a new audio connection for transmitting the interruption signal after cutting the audio connection that the amplifier 17 has already established. When the interruption signal reproduction ends by using the new audio connection, the car navigation apparatus cuts the audio connection for transmitting the interruption signal, and releases the exclusive control right. The description will be omitted for the above process by the transmitting apparatus which transmits the interruption signal, for convenience.

Finally, the car navigation apparatus 13 transmits, to all of the apparatuses functioning as the controller, the interruption signal reproduction end notification, as shown in FIG. 16. Namely, as shown in FIG. 17, the reproduction end notification receiving unit receives the interruption signal reproduction end notification from the car navigation apparatus (step S93). When receiving the signal reproduction end notification, the connection establishment request unit transmits, to the amplifier 17, the connection establishment request (the audio connection establishment request) to re-establish the audio connection with the DVD player 12, based on the pre-reproduction connection information retained by the pre-reproduction connection information retaining unit 403 (step S94).

The amplifier 17 which received the connection establishment request from the F-monitor 11 re-establishes the audio connection with the DVD player 12. Then, the amplifier 17 transmits, to the F-monitor 11, the connection establishment response (ACCEPTED) indicating that the connection establishment request is accepted and the connection is established.

The connection establishment response unit receives, from the amplifier 17, the connection establishment response (the audio connection establishment response) indicating that the audio connection with the DVD player 12 is re-established (step S95). Further, the connection establishment response unit determines whether or not the connection establishment request is accepted, based on the received connection establishment response (step S96). When the connection establishment request is rejected (step S96; No), the connection control monitoring unit 406 determines whether or not the retry of the connection establishment is possible, based on the factor of the rejection, i.e., the failure factor of the connection establishment (step S97). When the process can be continued by the retry, the connection control monitoring unit 406 determines that the retry of the connection establishment is possible, and executes the retry after the predetermined waiting time passes, with managing the number of retry times. Therefore, when the retry is possible (step S97; Yes), the connection control monitoring unit 406 repeatedly executes the process of steps S94 to S96. On the contrary, when the retry is not possible (step S97; No), the recovering process ends.

On the contrary, when the connection establishment request is accepted (step S96; Yes), the control apparatus control unit 400 ends the recovering process because it recovered the connection existed before the interruption signal reproduction.

As described above, the transmitting apparatus which transmits the interruption signal in this embodiment notifies, in advance, the start and the end of the reproduction of the interruption signal to the controllers, when it becomes necessary to reproduce the interruption signal on the network. Therefore, the controller can recognize the reproduction of the interruption signal in advance, and can retain the pre-reproduction connection information necessary for the switching of the connection after the interruption signal reproduction ends. Based on the pre-reproduction connection information, the controller can recover the connection existed before the interruption signal reproduction, after the interruption signal reproduction ends, with keeping the user unconscious.

Each of the controllers does not execute the connection operation after the interruption signal reproduction until the controller which should recover the original connection executes the recovering process. According to this, the controller which should recover the original connection (i.e., the controller which has established the original connection) executes the connection recovery within a predetermined time (e.g., 1 second), after receiving the interruption signal reproduction end notification.

Since the controller originally has a function to manage the connection, it is easy to mount the control apparatus control unit 400 for executing the recovering process.

### Modified Example

While the above embodiments describe only the audio signal for the interruption signal, the present invention is not limited to this. The present invention is applicable to the connection recovery of the video signal.

While it is not described in the above embodiments, in the case that each of the control units has an apparatus control unit and there is a source being reproduced before the interruption signal reproduction, if the source are the contents whose reproduction can be temporarily stopped such as the DVD player 12, the memory, the audio and the HDD, the reproduction of the source can be temporarily stopped before cutting the connection. By this, since the source is temporarily stopped at the time of reproducing the interruption signal, the user does not miss listening to the source being reproduced during the interruption signal reproduction. The apparatus control unit functions as the temporarily stopping means in the information processing apparatus of the present invention.

While it is not described in the above embodiments, when the exclusive control right setting request is transmitted, if it is possible to set the priority for the type of the signal, the start and the end of the interruption signal reproduction may be notified based on the priority.

### INDUSTRIAL APPLICABILITY

This invention can be used for a car AV system as an information processing apparatus capable of recovering the original connection after the interruption signal reproduction ends, based on the pre-reproduction connection information, by retaining the pre-reproduction connection information relating to the connection existing before the interruption signal reproduction, when the connection is switched for reproducing the interruption signal.

1.-12. (canceled)

13. A transmitting apparatus, connected to a receiving apparatus which reproduces a signal, for transmitting the signal, comprising:
a connection state confirmation request transmitting unit which transmits, to the receiving apparatus, a connection state confirmation request to confirm a connection state, when the connection between the transmitting apparatus and the receiving apparatus is switched to the connection for transmitting the interruption signal in order to reproduce the interruption signal;
a connection state confirmation response receiving unit which receives, from the receiving apparatus, a connection state confirmation response indicating the connection state;
a pre-reproduction connection information retaining unit which retains information relating to the transmitting apparatus and the receiving apparatus of the connection existing before a reproduction of the interruption signal, as pre-reproduction connection information, based on the connection state confirmation response; and
a recovering unit which recovers the connection existing before the reproduction of the interruption signal, based on the pre-reproduction connection information, after the reproduction of the interruption signal ends.

14. The transmitting apparatus according to claim 13, further comprising an exclusive control unit which exclusively controls the receiving apparatus to exclude an intervention by other apparatus,
wherein the exclusive control unit exclusively controls the receiving apparatus before the connection state confirmation request is transmitted until the connection existing before the reproduction of the interruption signal is recovered.

15. A control program executed by a transmitting apparatus, connected to a receiving apparatus which reproduces a signal, for transmitting the signal, the program making the transmitting apparatus function as:
a connection state confirmation request transmitting unit which transmits, to the receiving apparatus, a connection state confirmation request to confirm a connection state, when the connection between the transmitting apparatus and the receiving apparatus is switched to the connection for transmitting the interruption signal in order to reproduce the interruption signal;
a connection state confirmation response receiving unit which receives, from the receiving apparatus, a connection state confirmation response indicating the connection state;
a pre-reproduction connection information retaining unit which retains information relating to the transmitting apparatus and the receiving apparatus of the connection existing before a reproduction of the interruption signal, as pre-reproduction connection information, based on the connection state confirmation response; and
a recovering unit which recovers the connection existing before the reproduction of the interruption signal, based on the pre-reproduction connection information, after the reproduction of the interruption signal ends.
